(19) United States
(12) Patent Application Publication
(10) Pub. No.: US 2026/0303959 A1
(43) Pub. Date: Oct. 1, 2026

(54) Electronic Devices and Corresponding Methods for Augmenting Image Data with Skeletal Models for Enhanced Group Photography

(71) Applicant: Motorola Mobility LLC, Chicago, IL (US)

(72) Inventors: Amit Kumar Agrawal, Bangalore (IN); Rahul Bharat Desai, Hoffman Estates, IL (US); Philip Weinstein, Apex, NC (US)

(21) Appl. No.: 19/096,020

(22) Filed: Mar. 31, 2025

(51) Int. Cl. H04N 23/60; H04M 1/02; H04N 23/63; H04N 23/61

(52) U.S. Cl. CPC H04N 23/64; H04M 1/0268; H04N 23/632; H04N 23/633; H04M 1/022; H04M 2250/52; H04N 23/61

(57) ABSTRACT

A method in an electronic device includes one or more receiving image sensor data from an image sensor of an image capture device. The method can include the one or more processors using an image capture device to identify an object depicted within the image sensor data for designation as a focal point of one or more images to be captured by the image capture device. The one or more processors can augment the image sensor data to depict a skeletal model of a subject in a predefined position relative to depictions of the object to obtain an augmented image sensor data. The one or more processors can cause the augmented image sensor data to be presented on a user interface of the electronic device.

### BACKGROUND

### Technical Field

This disclosure relates generally to electronic devices, and more particularly to electronic devices having image capture devices.

### Background Art

In recent years, the advent of foldable smartphones has introduced new possibilities for enhancing user interaction and experience. These devices, with their advanced systems, offer opportunities for capturing images and videos in innovative ways.

However, capturing group photographs, especially those involving creative compositions with surrounding elements, remains a challenge. Traditional methods often require cumbersome setups, such as using additional equipment, and rely heavily on verbal cues to achieve the desired framing. This can be particularly difficult when attempting to include the photographer in the image or when trying to create the illusion of interacting with distant objects, such as landmarks or celestial bodies. It would be advantageous to have a more streamlined approach that leverages the capabilities of modern devices to facilitate the creation of visually appealing group photographs without the need for external assistance or complex equipment.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates one explanatory method in accordance with one or more embodiments of the disclosure.

FIGS. 3A-3F illustrate one or more method steps in accordance with one or more embodiments of the disclosure.

FIG. 4 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to receiving, by one or more processors from an image sensor of an image capture device, image sensor data, identifying, by the one or more processors using an image capture device, an object depicted within the image sensor data for designation as a focal point of one or more images to be captured by the image capture device, augmenting, by one or more processors, the image sensor data to depict a skeletal model of a subject in a predefined position relative to depictions of the object to obtain an augmented image sensor data, and causing, by the one or more processors, the augmented image sensor data to be presented on a user interface of the electronic device. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of using one or more processors to augment image sensor data received from a first image capture device to depict a model defined by reference locations situated at predefined features of a subject at a predefined position relative to a background object identified as a focal point by the one or more processors to obtain augmented image sensor data as described herein. In one or more embodiments, the one or more processors also cause the first display to present the augmented image sensor data while the first image capture device is operating in a viewfinder mode of operation.

The non-processor circuits may include, but are not limited to, a radio receiver, a radio transmitter, signal drivers, clock circuits, power source circuits, and user input devices. As such, these functions may be interpreted as steps of a method to perform identifying, by one or more processors, an object situated within a field of view of a first image capture device to be a focal point of one or more images, augmenting, by the one or more processors, image sensor data received from the first image capture device to depict a skeletal model of a subject interacting with depictions of the object to obtain augmented image sensor data, presenting, by the one or more processors, the augmented image sensor data on a first display, capturing, by the first image capture device while the augmented image sensor data is being presented on the first display, at least one image of a subject and the object when the subject sufficiently overlaps the skeletal model, augmenting, by the one or more processors, the at least one image to depict another skeletal model of another subject interacting with other depictions of the object to obtain at least one augmented image, presenting, by the one or more processors, the at least one augmented image on the first display while the first image capture device is operating in a viewfinder mode of operation, capturing, by the first image capture device while the at least one augmented image is being presented on the first display, at least one other image of another subject sufficiently overlaps the another skeletal model, synthesizing, by the one or more processors, the at least one image and the at least one other image to obtain a synthesized image depicting the subject and the another subject interacting with the object, and presenting, by the one or more processors, the synthesized image on a second display.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

As noted above, in the realm of modern photography, capturing group photographs that creatively incorporate background elements, such as landmarks or celestial bodies, presents a significant challenge. Traditional methods often require cumbersome setups, such as using additional equipment like tripods or selfie sticks or asking a passerby to take your photograph. Aside from potentially having your gear stolen, these techniques still rely heavily on verbal cues to achieve the desired framing. This can be particularly difficult when attempting to include the photographer in the image or when trying to create the illusion of interacting with distant objects. The need for precise alignment and coordination often results in awkward or unsatisfactory compositions, especially in dynamic environments or when involving multiple subjects.

Existing solutions in the field have attempted to address these challenges but come with notable disadvantages. For instance, some methods rely on manual adjustments and trial-and-error to achieve the desired composition, which can be time-consuming and frustrating for users. Others may employ basic overlays or guides on a single display, which can be insufficient for complex compositions involving multiple subjects and background elements. Additionally, these solutions often fail to provide real-time feedback or guidance, leading to misalignment and poor integration of subjects with the background.

Embodiments of the disclosure advantageously offer a novel approach to overcoming these limitations by leveraging the capabilities of modern electronic devices equipped with multi-camera and multi-display systems. In one or more embodiments, a method provides a way to augment image data with skeletal models to guide users in capturing visually appealing group photographs.

Illustrating by example, in one or more embodiments a method involves an electronic device equipped with one or more processors and an image capture device. In one or more embodiments, the process begins with the reception of image sensor data from the image sensor of the image capture device. The processors then identify an object within this image sensor data, designating the object as the focal point for one or more images to be captured.

Subsequently, the processors augment the image sensor data by depicting a skeletal model of a subject in a predefined position relative to the object, resulting in augmented image sensor data. This augmented data is then presented on a user interface of the electronic device, providing real-time guidance to the user for capturing visually appealing group photographs. Advantageously, this method leverages the capabilities of modern electronic devices to streamline the process of capturing complex compositions without the need for external assistance or cumbersome equipment.

By utilizing both front-facing and rear-facing displays, the system can present real-time guidance to both the photographer and the subjects, ensuring optimal alignment and interaction with background elements. This approach not only simplifies the process of capturing complex compositions but also enhances the overall user experience by reducing the need for external assistance or complex equipment. The method further allows for the seamless integration of multiple images into a single composite, providing a cohesive and aesthetically pleasing final result.

In one or more embodiments, an electronic device comprises a device housing that supports a front-facing image capture device, a front-facing display, and a rear-facing display, along with one or more processors. In one or more embodiments, the one or more processors are configured to augment image sensor data received from the front-facing image capture device by depicting a model defined by reference locations situated at predefined features of a subject at a predefined position relative to a background object identified as a focal point.

In one or more embodiments, this augmentation results in augmented image sensor data, which the processors then cause to be presented on the front-facing display while the front-facing image capture device operates in a viewfinder mode. This configuration allows users to receive real-time visual guidance for capturing images, ensuring that the subject is optimally positioned relative to the background object, thereby enhancing the quality and composition of the captured images.

Advantageously, this configuration allows for real-time visual guidance to be provided to the user, enhancing the ability to capture images with precise alignment and composition. By utilizing the front-facing display to present augmented image sensor data, the user can easily position the subject relative to the background object, ensuring optimal framing and interaction.

This approach reduces the need for external assistance or complex setups, streamlining the process of capturing aesthetically pleasing photographs. Additionally, the use of predefined reference locations for the skeletal model ensures that the subject is accurately positioned, improving the overall quality and consistency of the captured images. This method leverages the capabilities of modern electronic devices to provide an intuitive and efficient solution for capturing complex compositions, enhancing the user experience.

In one or more embodiments, a method involves an electronic device equipped with one or more processors and a first image capture device, which is configured to identify an object situated within the field of view to serve as a focal point for one or more images. In one or more embodiments, the method further includes augmenting the image sensor data received from the first image capture device to depict a skeletal model of a subject interacting with the object, thereby obtaining augmented image sensor data. In one or more embodiments, this augmented data is then presented on a first display, providing real-time visual guidance to the user for optimal alignment and interaction with the object. In one or more embodiments, the method also involves capturing at least one image of the subject and the object when the subject sufficiently overlaps the skeletal model, ensuring precise composition.

Subsequently, the method includes augmenting the captured image to depict another skeletal model of another subject interacting with other depictions of the object, resulting in at least one augmented image. This augmented image is presented on the first display while the first image capture device operates in a viewfinder mode. In one or more embodiments, the method further comprises capturing at least one other image of another subject when there is sufficient overlap with another skeletal model. The method then synthesizes the captured images to obtain a synthesized image depicting both the subject and another subject interacting with the object, which is then presented on a second display, thereby enhancing the overall user experience by facilitating the creation of complex and visually appealing group compositions.

Advantageously, this method provides a practical solution for capturing complex group compositions by utilizing skeletal models to guide the positioning of subjects relative to a focal object. By presenting augmented image sensor data on a display, users receive real-time visual guidance, ensuring precise alignment and interaction with the object. This approach reduces the need for verbal cues or trial-and-error adjustments, which are common in traditional photography methods. The synthesis of multiple images into a single composite image enhances the overall quality and aesthetic appeal of the final photograph, allowing for seamless integration of subjects with the background object. This method leverages the capabilities of modern electronic devices to streamline the process of capturing visually appealing group photographs, improving user experience and efficiency.

In one embodiment, the described method provides a technique for group composition using the external display of a multi-display device, which enhances the process of capturing group photographs by incorporating both the photographer and the subject in a seamless manner. In one or more embodiments, the method involves utilizing an electronic device equipped with a multi-camera and multi-display system to determine when a group composition is being triggered.

In one or more embodiments, this is achieved by capturing two separate photos: one where the photographer is not included and another where the subject is not included. The front display renders a camera preview facing the photographer, while the secondary display, facing the subject, is activated to guide the subject's positioning. The rear camera gathers data about the subject, and the front camera collects data about the photographer, using facial recognition and AI-based object detection algorithms to suggest suitable objects or landmarks in the frame.

In one or more embodiments, upon selection of an object or landmark, the system displays a skeletal user interface (UI) to guide the optimal positioning of both the subject and the photographer relative to the selected object. This skeletal UI is presented on the secondary display, allowing the photographer to capture the first photo of the subject interacting with the object.

Subsequently, the system displays another skeletal UI for the photographer to position themselves within the first photo, enabling the subject to capture the second photo. The system then merges the two photos into a single composition, which can be expanded to include more than two individuals, ensuring a cohesive and aesthetically pleasing final image. This method significantly reduces the need for external assistance or complex setups, providing an intuitive and efficient solution for capturing group photographs with precise alignment and composition.

Advantageously, this method allows for real-time guidance in capturing images, which is particularly useful in group photography where precise alignment with background elements is desired. By augmenting the image sensor data with a skeletal model, the system provides a visual guide for positioning subjects relative to the focal object, thereby facilitating the creation of complex compositions without the need for external assistance or cumbersome equipment.

This approach enhances the user experience by simplifying the process of capturing aesthetically pleasing photographs, reducing the reliance on verbal cues or trial-and-error adjustments. The integration of the skeletal model into the image data ensures that subjects are accurately positioned, improving the overall quality and consistency of the captured images. This method leverages the capabilities of modern electronic devices to provide an intuitive and efficient solution for capturing visually appealing group photographs. Other advantages will be described below. Still others will be obvious to those of ordinary skill in the art having the benefit of this disclosure.

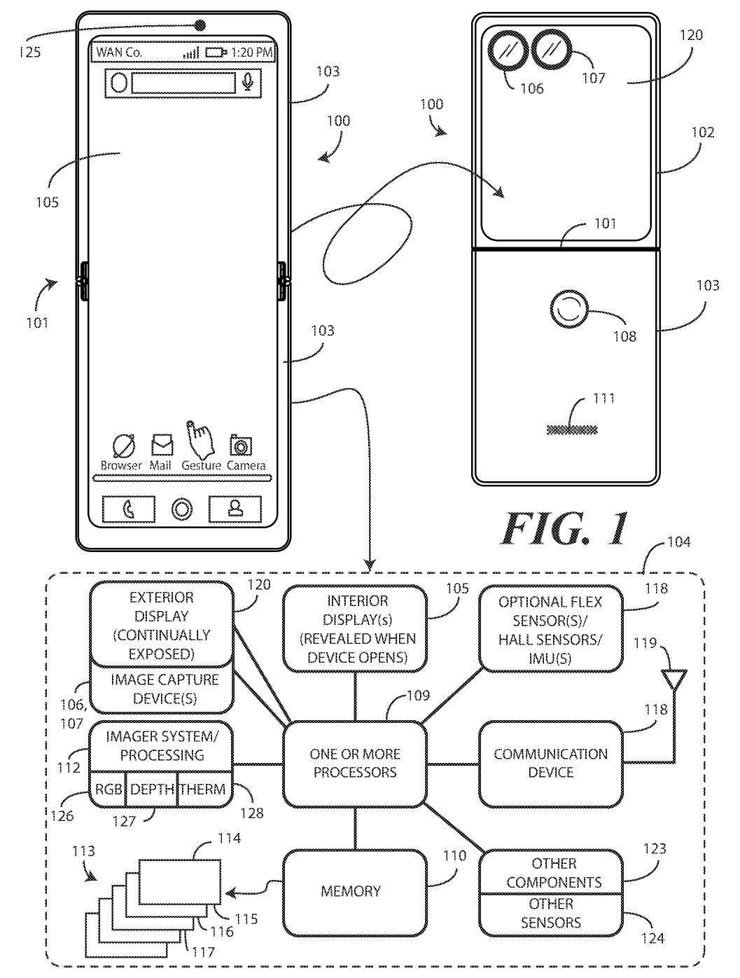

Turning now to FIG. 1, illustrated therein is one explanatory electronic device 100 configured in accordance with one or more embodiments of the disclosure. The electronic device 100 of FIG. 1 is a portable electronic device. For illustrative purposes, the electronic device 100 is shown as a smartphone. However, the electronic device 100 could be any number of other devices as well, including tablet computers, gaming devices, multimedia players, and so forth. Still other types of electronic devices can be configured in accordance with one or more embodiments of the disclosure as will be readily appreciated by those of ordinary skill in the art having the benefit of this disclosure.

The electronic device 100 includes a first device housing 102 and a second device housing 103. In one or more embodiments, a hinge 101 couples the first device housing 102 to the second device housing 103. In one or more embodiments, the first device housing 102 is selectively pivotable about the hinge 101 relative to the second device housing 103.

For example, in one or more embodiments the first device housing 102 is selectively pivotable about the hinge 101 between a closed position, a partially open position, and the open position shown in FIG. 1 where the first device housing 102 is in an axially displaced open position relative to the second device housing 103 about the hinge 101.

In one or more embodiments the first device housing 102 and the second device housing 103 are manufactured from a rigid material such as a rigid thermoplastic, metal, or composite material, although other materials can be used. Still other constructs will be obvious to those of ordinary skill in the art having the benefit of this disclosure. In the illustrative embodiment of FIG. 1, the electronic device 100 includes a single hinge 101. However, in other embodiments two or more hinges can be incorporated into the electronic device 100 to allow it to be folded in multiple locations.

While the illustrative electronic device 100 of FIG. 1 includes a hinge 101, embodiments of the disclosure are not so limited. In other embodiments, the electronic device 100 will be bendable, but will not include a hinge 101, such as when the first device housing 102 and the second device housing 103 are manufactured from bendable materials. In still other embodiments, the electronic device 100 can be bendable via a combination of hinge components and non-hinge components.

Illustrating by example, in another embodiment the electronic device housing can exclude a hinge and instead be flexible with a bending region that allows the electronic device housing to bend and flex between the axially displaced open position and the closed position. In such an embodiment, the electronic device housing may be manufactured from a malleable, bendable, or physically deformable material such as a flexible thermoplastic, flexible composite material, flexible fiber material, flexible metal, organic or inorganic textile or polymer material, or other materials. The electronic device housing could be formed from a single flexible housing member or from multiple flexible housing members.

In other embodiments, the electronic device housing could be a composite of multiple components. For instance, in another embodiment the electronic device housing could be a combination of rigid segments connected by hinges or flexible materials. Still other constructs will be obvious to those of ordinary skill in the art having the benefit of this disclosure.

In one or more embodiments the electronic device 100 of FIG. 1 includes at least one display 105. The illustrative embodiment of FIG. 1 includes multiple displays. Display 105 serves as a first display and is also referred to as the interior display or the rear-facing display.

In this illustrative embodiment, display 105 is concealed when the first device housing 102 is pivoted about the hinge 101 relative to the second device housing 103 to a closed position. Display 105 is then revealed when the first device housing 102 is pivoted about the hinge 101 relative to the second device housing 103 from the closed position to an axially displaced open position shown in FIG. 1. Thus, display 105 is revealed as the electronic device 100 transitions from the closed position where the first device housing 102 and the second device housing 103 abut to conceal the rear facing display 105 to the open position of FIG. 1.

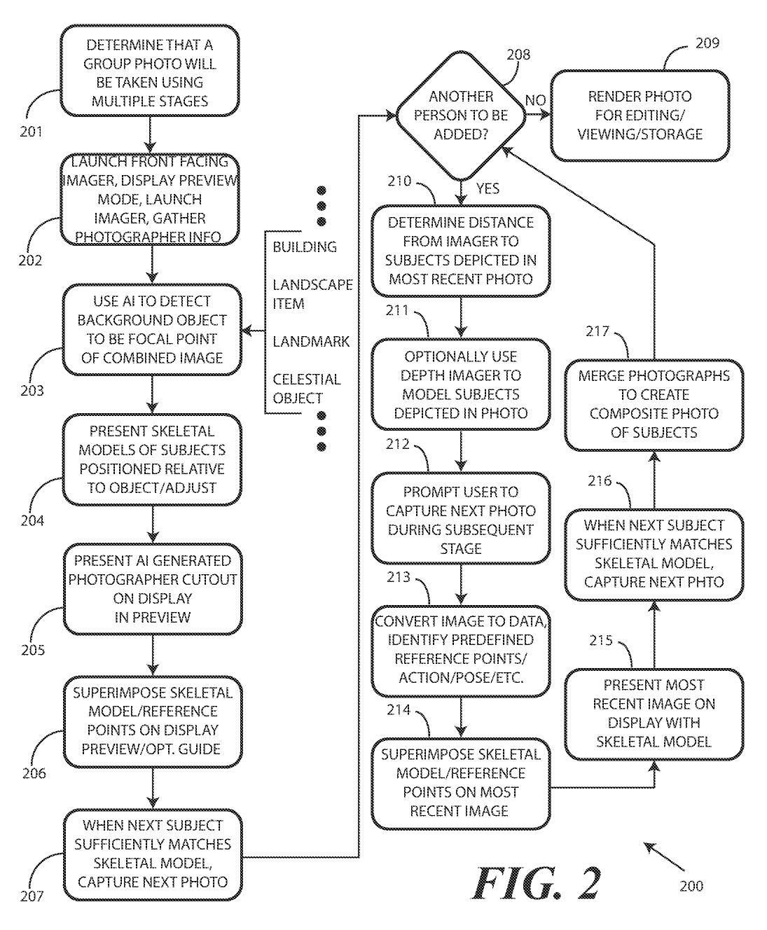

The electronic device 100 can optionally include at least one additional display. In the illustrative embodiment of FIG. 1, the electronic device 100 includes a front display 120, which can be referred to as an exterior display or front-facing display. This nomenclature regarding the “front facing display” and “rear facing display” arises due to the fact that the front display 120 is exposed both when the first device housing 102 and the second device housing 103 are pivoted about the hinge 101 to the closed position or the axially displaced open position. Thus, the front display 120 is exposed both in the axially displaced open position of FIG. 1 and the closed position of FIG. 2. In one or more embodiments, each of the rear display 105 and the front display 120 is a high-resolution display.

While shown coupled to the first device housing 102, it should be noted that the front display 120 could be coupled to either of the first device housing 102 or the second device housing 103. In other embodiments, the front display 120 can be coupled to the first device housing 102, while a third display (not shown) is coupled to the second device housing 103, and so forth. Thus, electronic devices configured in accordance with embodiments of the disclosure can include displays situated at different positions.

As with the front display 120, display 105 can also be coupled to either or both of the first device housing 102 or the second device housing 103. In this illustrative embodiment, display 105 is coupled to both the first device housing 102 and the second device housing 103 and spans the hinge 101. As noted above, display 105 is considered to be an “interior” display because it is concealed when the first device housing 102 and the second device housing 103 are in the closed position.

In one or more embodiments, either or both of display 105 and front display 120 can be touch-sensitive. Where this is the case, users can deliver user input to one or both of display 105 or the front display 120 by delivering touch input from a finger, stylus, or other objects disposed proximately with display 105 or the front display 120.

In the illustrative embodiment of FIG. 1, since display 105 spans the hinge 101, it is configured as a flexible display that can bend, deflect, and deform into different shapes. For instance, in one embodiment display 105 is configured as a foldable organic light emitting diode (OLED) display coupled to a foldable substrate.

The foldable substrate can be manufactured from various materials, including flexible plastic layers, flexible metal layers, flexible composite layers, or of other materials. In one embodiment, the foldable substrate is manufactured from stainless steel. Others will be obvious to those of ordinary skill in the art having the benefit of this disclosure. Where manufactured with a foldable substrate, this substrate allows display 105 to be flexible so as to deform when the first device housing 102 pivots about the hinge 101 relative to the second device housing 103.

In one or more embodiments, a user interface component 108, which may be a button or touch sensitive surface, can also be disposed along one or both of the first device housing 102 and/or the second device housing 103 to facilitate control of the electronic device 100. A speaker port 111 can be placed nearby.

In the illustrative embodiment of FIG. 1, the user interface component 108 comprises a button positioned on the second device housing 103. In other embodiments, the user interface component will be placed on the side of the first device housing 102 or second device housing 103, or to the side of front display 120. In still other embodiments, such as when the user interface component 108 is configured as a fingerprint sensor, it may be placed beneath the front facing display 120. Other locations for the user interface component 108 will be obvious to those of ordinary skill in the art having the benefit of this disclosure.

Other features can be added and can be located on the front of one or both of the first device housing 102 and/or the second device housing 103, sides of one or both of the first device housing 102 and/or the second device housing 103, and/or the rear of one or both of the first device housing 102 and/or the second device housing 103. Illustrating by example, in one or more embodiments a first image capture device 106 can be disposed on one side of the electronic device 100, while a second image capture device 125 is disposed on another side of the electronic device 100.

In the illustrative embodiment of FIG. 1, the first image capture device 106 and a third image capture device 107 are disposed on a front-facing side of the first device housing 102, while the second image capture device 125 is situated on a rear-facing side of the first device housing 102. As shown in FIG. 1, in this illustrative embodiment the front facing display 120 has a display perimeter that is defined by the outermost boundary of the area occupied by the front facing display 120 on the second device housing 103. In this illustrative embodiment, the first image capture device 106 and the third image capture device 107 are situated within this display perimeter.

In one or more embodiments, the first image capture device 106 and the third image capture device 107 can be different types of image capture devices. Illustrating by example, the first image capture device 106 may be a wide field of view image capture device, while the third image capture device 107 is a telephoto image capture device, and so forth. In one or more embodiments, the first image capture device 106 and the third image capture device 107 can be used to capture images of front-facing subjects, while the second image capture device 125 can be used for rear-facing subjects, such as when a user of the electronic device 100 is capturing a “selfie.”

In other embodiments, the first image capture device 106 and the third image capture device 107 could be positioned beneath the front facing display 120. Illustrating by example, in such an embodiment the front facing display 120 may comprise a first pixel portion and a second pixel portion. In one embodiment, the first pixel portion comprises only transparent organic light emitting diode pixels. In another embodiment, the pixels disposed in the first pixel portion comprise a combination of transparent organic light emitting diode pixels and reflective organic light emitting diode pixels. Other configurations will be obvious to those of ordinary skill in the art having the benefit of this disclosure.

In such an embodiment, the entire extent of the front facing display 120 would be available for presenting images. In the illustrative embodiment of FIG. 1, the first image capture device 106 and the third image capture device 107 are situated within apertures defined by the extent of the front facing display 120 within the outer display perimeter. As such, content is not presented within the outer perimeters of the first image capture device 106 and the third image capture device 107. This configuration allows for lenses and other components to be situated atop the image sensors of each of the first image capture device 106 and the third image capture device 107.

While some borders are shown in FIG. 1, in other embodiments there is no need for the first device housing 102 of the electronic device 100 to include borders that picture frame the front facing display 120 or the rear facing display 105. To the contrary, in other embodiments one or both of the rear facing display 105 and/or the front facing display 120 can span an entire major face of the electronic device 100 so that the entirety of the major face can be used as active display area.

One way that the amount of surface area of the first device housing 102 and the second device housing 103 covered by the rear display 105 or the front display 120 can be expanded is by placing the various sensors, e.g., image capture devices and the fingerprint sensor, beneath the first pixel portion of a display as previously described. This allows the fingerprint sensor, the image capture devices, and/or the other sensors to receive signals through the transparent portions of the first pixel portion.

A block diagram schematic 104 of the electronic device 100 is also shown in FIG. 1. In one or more embodiments, the block diagram schematic 104 is configured as a printed circuit board assembly disposed within one or both of the first device housing 102 or the second device housing 103. Various components can be electrically coupled together by conductors or a bus disposed along one or more printed circuit boards, which can optionally be flexible circuit boards or alternatively rigid circuit boards coupled together by one or more flexible conductors or substrates. It should be noted that the block diagram schematic 104 includes many components that are optional, but which are included in an effort to demonstrate how varied electronic devices configured in accordance with embodiments of the disclosure can be.

Thus, it is to be understood that the block diagram schematic 104 of FIG. 1 is provided for illustrative purposes only and for illustrating components of one electronic device 100 in accordance with embodiments of the disclosure. The block diagram schematic 104 of FIG. 1 is not intended to be a complete schematic diagram of the various components required for an electronic device 100. Therefore, other electronic devices in accordance with embodiments of the disclosure may include various other components not shown in FIG. 1 or may include a combination of two or more components or a division of a particular component into two or more separate components and still be within the scope of the present disclosure.

In one embodiment, the electronic device 100 includes one or more processors 109. The one or more processors 109 can be a microprocessor, a group of processing components, one or more Application Specific Integrated Circuits (ASICs), programmable logic, or other type of processing device. The one or more processors 109 can be operable with the various components of the electronic device 100. The one or more processors 109 can be configured to process and execute executable software code to perform the various functions of the electronic device 100. A storage device, such as memory 110, can optionally store the executable software code used by the one or more processors 109 during operation.

In one or more embodiments, the one or more processors 109, in response to either the first image capture device 106 or the third image capture device 107 receiving image sensor data, identify an object depicted within the image sensor data for designation as a focal point of one or more images to be captured by either the first image capture device 106 or the third image capture device 107. This identification process can be achieved through multiple techniques, each offering distinct advantages.

Illustrating by example, one technique involves the use of advanced image recognition algorithms that analyze the image sensor data to detect and classify objects based on predefined criteria, such as shape, color, or size. This method is advantageous for its speed and accuracy, allowing for real-time identification of focal points even in dynamic environments.

Another technique employs machine learning models trained on vast data sets to recognize and prioritize objects that are commonly of interest, such as faces or landmarks. This approach enhances the system's ability to adapt to various contexts and user preferences, providing a personalized photography experience.

Additionally, the one or more processors 109 can utilize depth sensing technology to determine the spatial relationship between objects within the field of view, enabling the selection of a focal point based on prominence or relevance in the scene. This technique is particularly beneficial in complex compositions where multiple objects are present, ensuring that the most significant element is highlighted in the captured images. By leveraging these techniques, the one or more processors 109 enhance the functionality of the image capture devices, facilitating the creation of visually striking photographs with minimal user intervention.

In one or more embodiments, the one or more processors 109, in response to either the first image capture device 106 or the third image capture device 107 receiving image sensor data, augment the image sensor data with a model of a subject in a predefined position relative to depictions of the object to obtain augmented image sensor data. In one or more embodiments the skeletal model is defined by reference locations situated at predefined features of a subject at a position relative to depictions of the object. This selection can be achieved through several methods, each offering distinct advantages.

One method involves utilizing advanced image recognition algorithms to analyze the image sensor data and identify optimal positions based on predefined criteria such as symmetry, balance, or aesthetic appeal. This approach ensures that the subject is positioned in a visually pleasing manner relative to the focal object, enhancing the overall composition of the photograph.

Another method employs machine learning models trained on large datasets to predict and suggest positions that are commonly preferred by users, such as the rule of thirds or golden ratio placements. This technique provides a personalized photography experience by adapting to user preferences and trends.

Additionally, the processors can use depth sensing technology to determine the spatial relationship between the subject and the object, allowing for dynamic adjustments to the predefined position based on real-time environmental changes. This method is particularly beneficial in complex scenes where multiple elements are present, ensuring that the subject is optimally aligned with the focal object. By leveraging these methods, the processors enhance the functionality of the image capture devices, facilitating the creation of visually striking photographs with minimal user intervention.

In one or more embodiments, the one or more processors 109 can then cause the front facing display 120 to present the augmented image sensor data. In one or more embodiments, this presentation occurs while either the first image capture device 106 or the third image capture device 107 is in a viewfinder mode of operation.

In one or more embodiments, the one or more processors 109 are further configured to present at least portions of viewfinder image content depicting the subject with the augmented image sensor data while either the first image capture device 106 or the third image capture device 107 is in the viewfinder mode of operation when the second subject is within a field of view of either the first image capture device 106 or the third image capture device 107 that is capturing the next image.

In one or more embodiments, the one or more processors 109 cause either the first image capture device 106 or the third image capture device 107 to capture an image once the at least portions of the viewfinder image content depict the subject overlapping the model by a predefined overlapping amount. Accordingly, in one or more embodiments one or more processors 109 are configured to augment image sensor data received from either the first image capture device 106 or the third image capture device 107 to depict a model defined by reference locations situated at predefined features of a subject at a predefined position relative to a background object identified as a focal point by the one or more processors 109 to obtain augmented image sensor data and cause the front facing display 120 to present the augmented image sensor data while either the first image capture device 106 or the third image capture device 107 is operating in a viewfinder mode of operation.

In one or more embodiments, where the photographer will be in the group photograph, the one or more processors 109 can cause the second image capture device 125 to capture images of the photographer. Thereafter, the one or more processors 109 can be configured to further augment the image sensor data received from either the first image capture device 106 or the third image capture device 107 with other image capture device received from the second image capture device 125 depicting a user performing an image capture operation at another predefined position relative to the background object.

Moreover, in one or more embodiments one or more processors 109, upon either the first image capture device 106 or the third image capture device 107 capturing an image depicting a first subject in the predefined position, augment the image with another model defined by other reference locations situated at other predefined features of a second subject at another position relative to first facing display to present the other augmented image while the first image capture device is in the viewfinder mode of operation.

In one or more embodiments, the one or more processors 109 either the first image capture device 106 or the third image capture device 107 to capture another image once the second subject overlaps the model by a predefined overlapping amount. In one or more embodiments, the one or more processors 109 further synthesize the image and another image to obtain a composite image depicting the first subject and the second subject at the position relative to the depictions of the object defining the focal point of the image.

To illustrate how the electronic device 100 and its technique for using a skeletal model, and optionally image sensor data captured of a photographer, can be beneficial in capturing images where an object is designated as a focal point, consider some examples. In one illustrative use case the electronic device 100 facilitates the creation of imaginative group photographs by designating different objects as focal points and guiding subjects to position themselves creatively relative to these objects.

For instance, in one scenario, two individuals might be directed to stand in such a way that they appear to support a giant chicken leg painted on the side of Buster’s World-Famous Chicken Shack, creating a whimsical illusion of holding the oversized object. In another example, a person might be positioned to appear as if they are supporting the Leaning Tower of Pisa with their hands, while a second person stands behind them, seemingly pushing their back to enhance the playful interaction with the iconic landmark.

Additionally, the system can guide a person to kneel and position their hand in a manner that makes the photograph look like they are holding the sun while proposing, adding a romantic and dramatic flair to the image. Further illustrating the versatility of the described technology, Amit and his wife could be directed to climb the tallest peak in Karnataka and form a heart shape with their hands, framing the sun within the heart, thus capturing a moment of personal significance against a breathtaking backdrop.

Beyond these examples, the described technology can be used to create a photograph where a group of friends appears to be lifting a large boulder together, symbolizing teamwork and strength. Another scenario might involve a child standing on tiptoe, seemingly reaching up to touch the top of a tall tree, evoking a sense of wonder and growth. In another example, a family could be arranged to appear as if they are holding up a rainbow, with each member positioned to support a different color, symbolizing unity and diversity.

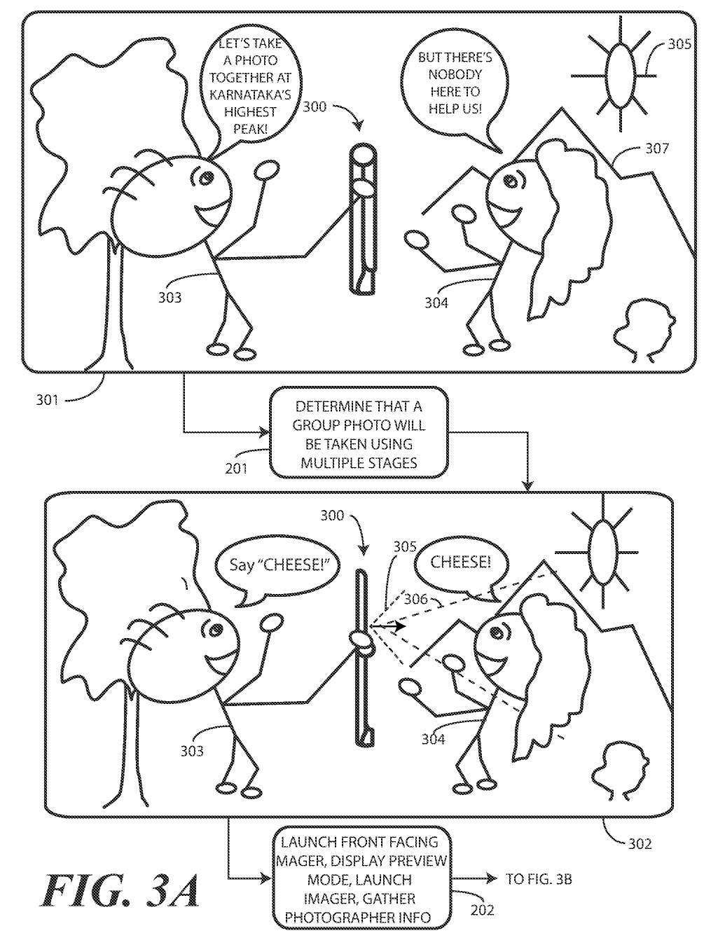

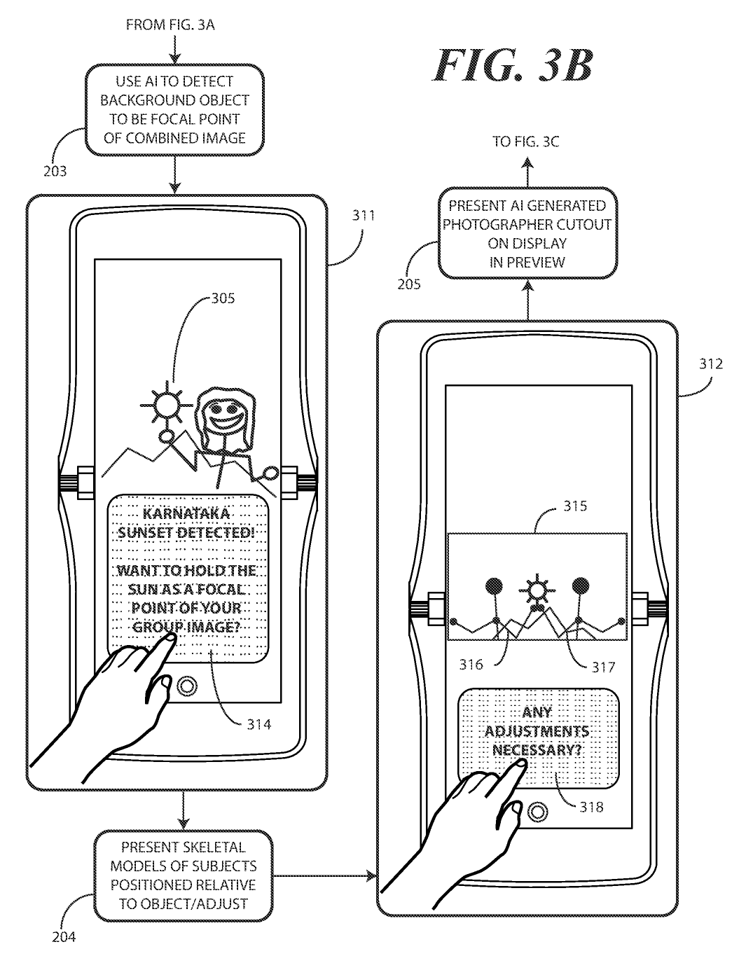

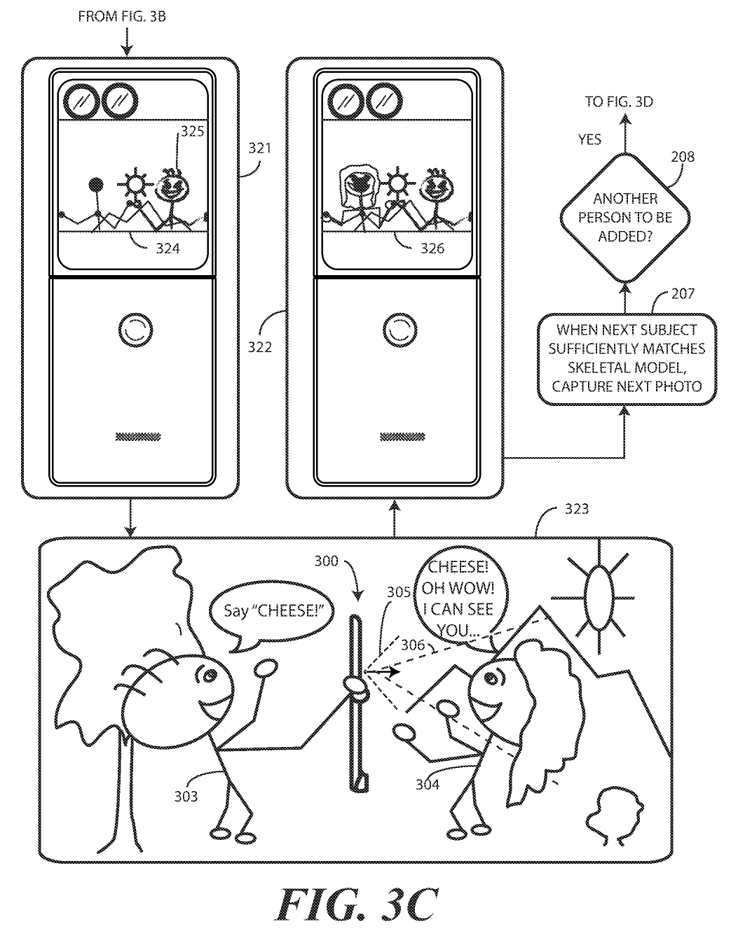

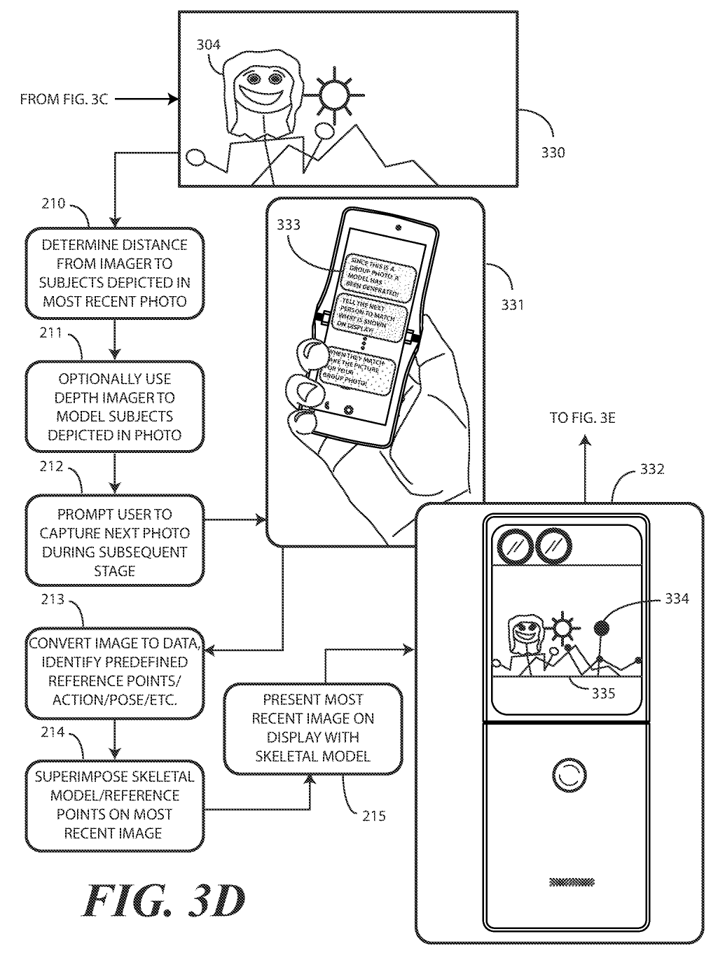

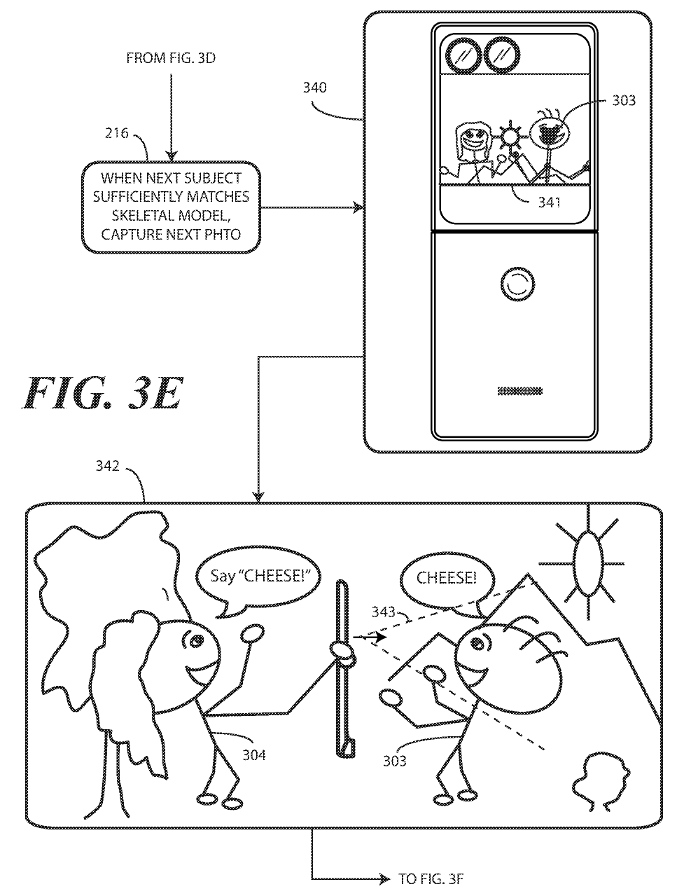

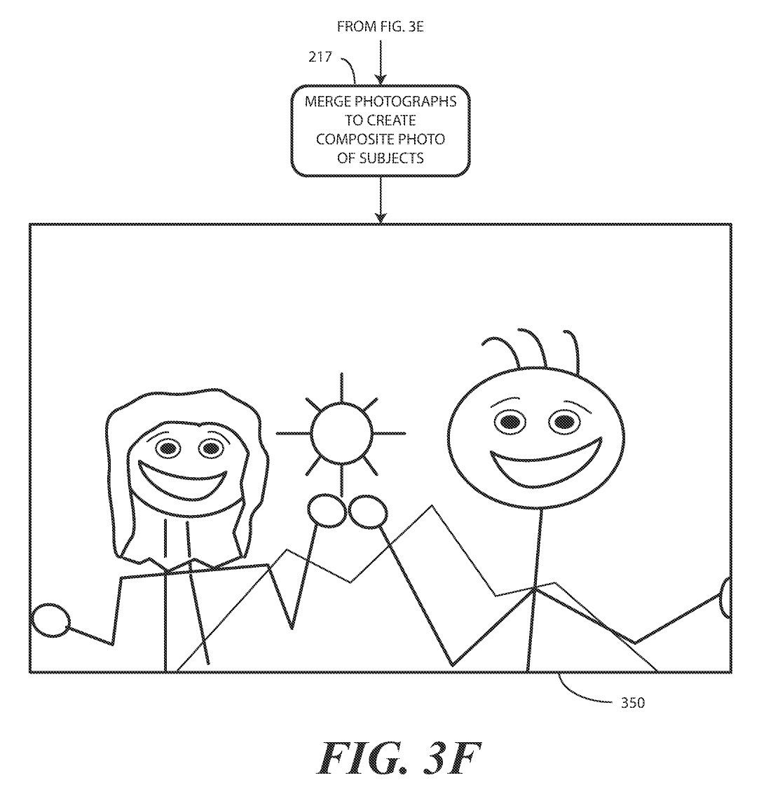

These use cases demonstrate the described technology's ability to transform ordinary photographs into extraordinary visual narratives by leveraging the capabilities of modern electronic devices. Other examples will be illustrated in FIGS. 3A-3F. Still others will be obvious to those of ordinary skill in the art having the benefit of this disclosure.

In effect, the one or more processors 109 facilitate group composition photographs by capturing sequential images and using an external display 120 of a multi-display device. In one or more embodiments, the one or more processors 109 use either the first image capture device 106 or the third image capture device 107 in a sequence of steps designed to enhance the process of capturing group photographs. The rear facing display 105 can optionally be used to position the photographer in the image sensor data so that the subjects can see where the photographer will ultimately be positioned.

Initially, the one or more processors 109 use one or more sensors 124 or a user interface such as the rear-facing display 105 to determine that a group composition is being initiated with the photographer needing to be included in the final image. In one or more embodiments, this process requires capturing at least two separate images: a first image excludes the photographer and a second image that includes the photographer.

In one or more embodiments during the first image capture, the rear facing display 105 shows the camera preview captured by either the first image capture device 106 or the third image capture device 107, while the front facing display 120 facing the subject, is activated. Upon either the first image capture device 106 or the third image capture device 107 capturing the first image, the one or more processors 109 use a depth imager 127 to record the distance to the first subject. Advantageously, this distance measurement ensures precise spatial data is available for subsequent steps.

After the first composition is complete, the one or more processors 109 prompt the photographer to capture the second image, which the one or more processors 109 will superimpose on the first image. In one or more embodiments, the one or more processors 109 cause the front facing display 120 to present the first composition combined with a skeletal cutout of the second subject that is superimposed on this first image using stereo depth information from the depth imager. This “visual guide” allows the second user to accurately position themselves within the composition. Once both compositions are captured, they are merged to create a seamless group photo, effectively addressing the challenges of aligning multiple compositions by leveraging the dual-display form factor.

Thus, in one or more embodiments the one or more processors 109 augment the first image by superimposing the model on the first image. Where the electronic device 100 comprises a depth imager 127, the one or more processors 109 can use a distance the first subject is from either the first image capture device 106 or the third image capture device 107 when the first image is captured as an input into a function determining the size of the model. In other embodiments, such as where the first image depicts an inanimate object like a car, building, house, tree, light post, restaurant such as the world famous Buster’s Chicken Shack, or other inanimate object, a size of the model can be determined as a function of the size of depictions of the first subject in comparison to a size of the depictions of the inanimate object.

It should be noted that in this illustrative embodiment both of the first image capture device 106 and the third image capture device 107 are coupled to the first device housing 102 and are each exposed both when the first device housing 102 and the second device housing 103 are in the closed position and when the first device housing 102 and the second device housing 103 are in the axially displaced open position of FIG. 1. Embodiments of the disclosure contemplate that when the electronic device 100 is in the axially displaced open position, users will typically use the rear facing display 105 as a user interface since the rear facing display 105 is generally a touch-sensitive display.

In one or more embodiments, the one or more processors 109 are further responsible for performing the primary functions of the electronic device 100. For example, in one embodiment the one or more processors 109 comprise one or more circuits operable to present presentation information, such as images, text, and video, on one or both of the rear facing display 105 and/or the front facing display 120. The executable software code used by the one or more processors 109 can be configured as one or more modules 113 stored in the memory 110 that are operable with the one or more processors 109. Such modules can store instructions, control algorithms, and so forth.

In one embodiment, the one or more processors 109 are responsible for running the operating system environment 114. The operating system environment can include a kernel 115, one or more drivers, an application service layer 116, and an application layer 117. The operating system environment can be configured as executable code operating on one or more processors or control circuits of the electronic device 100.

In one or more embodiments, the one or more processors 109 are responsible for managing the applications of the electronic device 100. In one or more embodiments, the one or more processors 109 are also responsible for launching, monitoring and killing the various applications and the various application service modules. The applications of the application layer can be configured as clients of the application service layer to communicate with services through application program interfaces (APIs), messages, events, or other inter-process communication interfaces.

In this illustrative embodiment, the electronic device 100 also includes a communication device 118 that can be configured for wired or wireless communication with one or more other devices or networks. The networks can include a wide area network, a local area network, and/or personal area network. The communication device 118 may also utilize wireless technology for communication, such as, but are not limited to, peer-to-peer or ad hoc communications, and other forms of wireless communication such as infrared technology. The communication device 118 can include wireless communication circuitry, one of a receiver, a transmitter, or transceiver, and one or more antennas 119.

In one embodiment, the electronic device 100 includes one or more sensors 124 operable to determine a geometric form factor of the electronic device 100. Illustrating by example, in one or more embodiments the one or more sensors 124 operable to detect the geometric form factor of the electronic device 100 detect angles between the first device housing 102 and the second device housing 103 as these device housings pivot relative to each other about the hinge 101. The one or more sensors 124 operable to determine a geometric form factor of the electronic device 100 can detect the first device housing 102 pivoting about the hinge 101 relative to the second device housing 103. The one or more sensors 124 operable to determine the geometric form factor can take various forms.

In one or more embodiments, the one or more sensors 124 operable to determine the geometric form factor of the electronic device 100 comprise one or more flex sensors supported by the first device housing 102 and/or second device housing 103 and operable with the one or more processors 109 to detect a bending operation deforming the electronic device 100 into a deformed geometric form factor, examples of which are shown below in FIGS. 2 and 3. The inclusion of flex sensors is optional, and in some embodiment flex sensors will not be included.

Where included, in one embodiment the flex sensors each comprise passive resistive devices manufactured from a material with an impedance that changes when the material is bent, deformed, or flexed. By detecting changes in the impedance as a function of resistance, the one or more processors 109 can use the one or more flex sensors to detect bending or flexing. In one or more embodiments, each flex sensor comprises a bi-directional flex sensor that can detect flexing or bending in two directions. In one embodiment, the one or more flex sensors have an impedance that increases in an amount that is proportional with the amount it is deformed or bent.

In one embodiment, each flex sensor is manufactured from a series of layers combined into a stacked structure. In one embodiment, at least one layer is conductive, and is manufactured from a metal foil such as copper. A resistive material provides another layer. These layers can be adhesively coupled together in one or more embodiments. The resistive material can be manufactured from a variety of partially conductive materials, including paper-based materials, plastic-based materials, metallic materials, and textile-based materials. In one embodiment, a thermoplastic such as polyethylene can be impregnated with carbon or metal so as to be partially conductive, while at the same time being flexible.

In one embodiment, the resistive layer is sandwiched between two conductive layers. Electrical current flows into one conductive layer, through the resistive layer, and out of the other conductive layer. As the flex sensor bends, the impedance of the resistive layer changes, thereby altering the flow of current for a given voltage. The one or more processors 109 can detect this change to determine an amount of bending. Taps can be added along each flex sensor to determine other information, including the number of folds, the degree of each fold, the location of the folds, the direction of the folds, and so forth. The flex sensor can further be driven by time-varying signals to increase the amount of information obtained from the flex sensor as well.

While a multi-layered device as a flex sensor is one configuration suitable for detecting a bending operation occurring to deform the electronic device 100 and a geometric form factor of the electronic device 100 after the bending operation, other sensors 124 for detecting the geometric form factor of the electronic device 100 can be used as well. For instance, a magnet can be placed in the first device housing 102 while a magnetic sensor is placed in the second device housing 103, or vice versa. The magnetic sensor could be Hall-effect sensors, a giant magnetoresistance effect sensor, a tunnel magnetoresistance effect sensor, an anisotropic magnetoresistive sensor, or other type of sensor.

In still other embodiments, the one or more sensors 124 operable to determine a geometric form factor of the electronic device 100 can comprise an inductive coil placed in the first device housing 102 and a piece of metal placed in the second device housing 103, or vice versa. When the metal is in close proximity to the coil, the one or more sensors 124 operable to determine the geometric form factor of the electronic device 100 detect the first device housing 102 and the second device housing 103 in a first position. By contrast, when the metal is farther away from the coil, the one or more sensors 124 operable to determine a geometric form factor of the electronic device 100 can detect the first device housing 102 and the second device housing 103 being in a second position, and so forth.

In other embodiments the one or more sensors 124 operable to determine a geometric form factor of the electronic device 100 can comprise an inertial motion unit situated in the first device housing 102 and another inertial motion unit situated in the second device housing 103. The one or more processors 109 can compare motion sensor readings from each inertial motion unit to track the relative movement and/or position of the first device housing 102 relative to the second device housing 103, as well as the first device housing 102 and the second device housing 103 relative to the direction of gravity. This data can be used to determine and or track the state and position of the first device housing 102 and the second device housing 103 directly as they pivot about the hinge 101, as well as their orientation with reference to a direction of gravity.

Where included as the one or more sensors 124 operable to determine the geometric form factor of the electronic device 100, each inertial motion unit can comprise a combination of one or more accelerometers, one or more gyroscopes, and optionally one or more magnetometers, to determine the orientation, angular velocity, and/or specific force of one or both of the first device housing 102 or the second device housing 103. When included in the electronic device 100, these inertial motion units can be used as orientation sensors to measure the orientation of one or both of the first device housing 102 or the second device housing 103 in three-dimensional space. Similarly, the inertial motion units can be used as orientation sensors to measure the motion of one or both of the first device housing 102 or second device housing 103 in three-dimensional space. The inertial motion units can be used to make other measurements as well.

Where only one inertial motion unit is included in the first device housing 102, this inertial motion unit is configured to determine an orientation, which can include measurements of azimuth, plumb, tilt, velocity, angular velocity, acceleration, and angular acceleration, of the first device housing 102. Similarly, where two inertial motion units are included, with one inertial motion unit being situated in the first device housing 102 and another inertial motion unit being situated in the second device housing 103, each inertial motion unit determines the orientation of its respective device housing. Inertial motion unit can determine measurements of azimuth, plumb, tilt, velocity, angular velocity, acceleration, angular acceleration, and so forth of the first device housing 102, while inertial motion unit can determine measurements of azimuth, plumb, tilt, velocity, angular velocity, acceleration, angular acceleration, and so forth of the second device housing 103, and so forth.

In one or more embodiments, each inertial motion unit delivers these orientation measurements to the one or more processors 109 in the form of orientation determination signals. Thus, the inertial motion unit situated in the first device housing 102 outputs a first orientation determination signal comprising the determined orientation of the first device housing 102, while the inertial motion unit situated in the second device housing 103 outputs another orientation determination signal comprising the determined orientation of the second device housing 103.

In one or more embodiments, the orientation determination signals are delivered to the one or more processors 109, which report the determined orientations to the various modules, components, and applications operating on the electronic device 100. In one or more embodiments, the one or more processors 109 can be configured to deliver a composite orientation that is an average or other combination of the orientation of orientation determination signals. In other embodiments, the one or more processors 109 are configured to deliver one or the other orientation determination signal to the various modules, components, and applications operating on the electronic device 100.

In another embodiment the one or more sensors 124 operable to determine the geometric form factor of the electronic device 100 comprise proximity sensors that detect how far a first end of the electronic device 100 is from a second end of the electronic device 100. Still other examples of the one or more sensors 124 operable to determine a geometric form factor of the electronic device 100 will be obvious to those of ordinary skill in the art having the benefit of this disclosure.

In one or more embodiments, the one or more sensors 124 operable to determine the geometric form factor of the electronic device 100 can comprise an image capture analysis/synthesis manager 112. When the electronic device 100 is bent at the hinge 101 with, for example, the rear facing image capture device 125 determining the geometric form factor by processing images from the rear facing image capture device 125 to determine the angle of the bend.

In one or more embodiments, one or more of the first image capture device 106, the second image capture device 125, and the third image capture device 107 comprise an intelligent imager. Where configured as an intelligent imager, each image capture device 106,107,125 can capture one or more images of environments about the electronic device 100 and determine whether the object matches predetermined criteria.

For example, the intelligent imager operates as an identification module configured with optical recognition such as include image recognition, character recognition, visual recognition, facial recognition, color recognition, shape recognition and the like. In yet another embodiment, the intelligent imager can determine where a user’s eyes or face are located in three-dimensional space relative to the electronic device 100.

To capture data depicting a subject performing the activity, a variety of devices, alone or in combination, can be included in the block diagram schematic 104. Illustrating by example, one or more of the first image capture device 106, the second image capture device 125, and the third image capture device 107 can include an imager 126, a depth imager 127, and, optionally, a thermal sensor 128. Others will be obvious to those of ordinary skill in the art having the benefit of this disclosure.

In one embodiment, the imager 126 comprises a two-dimensional imager configured to receive at least one image of the subject when performing the activity. In one embodiment, the imager 126 comprises a two-dimensional Red-Green-Blue (RGB) imager. In another embodiment, the imager 126 comprises an infrared imager. Other types of imagers suitable for use as the imager 126 to capture images of the subject performing the activity will be obvious to those of ordinary skill in the art having the benefit of this disclosure.

Where included, the thermal sensor 128 can also take various forms. In one embodiment, the thermal sensor 128 is simply a proximity sensor component comprising an infrared receiver without a corresponding transmitter. In another embodiment, the thermal sensor 128 comprises a simple thermopile. In another embodiment, the thermal sensor 128 comprises an infrared imager that captures the amount of thermal energy emitted by an object. Other types of thermal sensors 128 will be obvious to those of ordinary skill in the art having the benefit of this disclosure.

Where included, the depth imager 127 can take a variety of forms. In a first embodiment, the depth imager 127 comprises a pair of imagers separated by a predetermined distance, such as three to four images. This “stereo” imager works in the same way the human eyes do in that it captures images from two different angles and reconciles the two to determine distance.

In another embodiment, the depth imager 127 employs a structured light laser. The structured light laser projects tiny light patterns that expand with distance. These patterns land on a surface, such as the body of the subject when performing the activity and are then captured by an imager. By determining the location and spacing between the elements of the pattern, three-dimensional mapping can be obtained.

In still another embodiment, the depth imager 127 comprises a time-of-flight device. Time of flight three-dimensional sensors emit laser or infrared pulses from a photodiode array. These pulses reflect back from a surface, such as the body of the subject when performing the activity. The time it takes for pulses to move from the photodiode array to the surface and back determines distance, from which a three-dimensional mapping of a surface can be obtained. Regardless of embodiment, the inclusion of a depth imager 127 can provide a third “z-dimension” to the x-dimension and y-dimension defining the two-dimensional image captured by the imager 126, thereby allowing for three-dimensional, and even holographic, feedback to be provided to the subject.

In addition to, or instead of the intelligent imager, one or more proximity sensors included with the other sensors 124 can determine to which side of the electronic device 100 the user is positioned when the electronic device 100 is deformed. The proximity sensors can include one or more proximity sensor components. The proximity sensors can also include one or more proximity detector components. In one embodiment, the proximity sensor components comprise only signal receivers. By contrast, the proximity detector components include a signal receiver and a corresponding signal transmitter.

In one embodiment, the proximity sensor components comprise an infrared signal receiver so as to be able to detect infrared emissions from a person. Accordingly, the proximity sensor components require no transmitter since objects disposed external to the electronic device 100 deliver emissions that are received by the infrared receiver. As no transmitter is required, each proximity sensor component can operate at a very low power level.

In one embodiment, one or more proximity detector components can each include a signal receiver and a corresponding signal transmitter. The signal transmitter can transmit a beam of infrared light that reflects from a nearby object and is received by a corresponding signal receiver. The proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

In one embodiment, the one or more processors 109 may generate commands or execute control operations based on information received from the various sensors 124 and other components 123, including the one or more sensors 124 operable to determine the geometric form factor of the electronic device 100, the first image capture device 106, the second image capture device 125, or other components of the electronic device. The one or more processors 109 may also generate commands or execute control operations based upon information received from a combination of these components. Moreover, the one or more processors 109 may process the received information alone or in combination with other data, such as the information stored in the memory 110.

The other sensors 124 and other components 123 may include a microphone, an earpiece speaker, a loudspeaker, key selection sensors, a touch pad sensor, a touch screen sensor, a capacitive touch sensor, and one or more switches. Touch sensors may be used to indicate whether any of the user actuation targets present on the rear display 105 are being actuated. Alternatively, touch sensors can determine if the front display 120 is being touched to determine whether fingerprint data is being delivered to the fingerprint sensor. The touch sensors can include surface and/or housing capacitive sensors in one embodiment.

The other sensors 124 and components 123 can also include motion detectors, such as one or more accelerometers or gyroscopes. For example, an accelerometer may be embedded in the electronic circuitry of the electronic device 100 to show vertical orientation, constant tilt and/or whether the electronic device 100 is stationary. The measurement of tilt relative to gravity is referred to as “static acceleration,” while the measurement of motion and/or vibration is referred to as “dynamic acceleration.” A gyroscope can be used in a similar fashion. In one embodiment the motion detectors are also operable to detect movement, and direction of movement, of the electronic device 100 by a user.

In one or more embodiments, the other sensors 124 and components 123 include a gravity detector. For example, as one or more accelerometers and/or gyroscopes may be used to show vertical orientation, constant, or a measurement of tilt relative to gravity. Accordingly, in one or more embodiments, the one or more processors 109 can use the gravity detector to determine an orientation of the electronic device 100 in three-dimensional space relative to the direction of gravity.

The other sensors 124 and components 123 operable with the one or more processors 109 can include output components such as video outputs, audio outputs, and/or mechanical outputs. Examples of output components include audio outputs, an earpiece speaker, haptic devices, or other alarms and/or buzzers and/or a mechanical output component such as vibrating or motion-based mechanisms. Still other components will be obvious to those of ordinary skill in the art having the benefit of this disclosure.

It is to be understood that FIG. 1 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 1 or may include a combination of two or more components or a division of a particular component into two or more separate components and still be within the scope of the present disclosure.

Turning now to FIG. 2, illustrated therein is one explanatory method 200 for using the electronic device (100) of FIG. 1. At step 201 of FIG. 2, the one or more processors of an electronic device can determine that a group photograph will be taken in multiple stages. In one or more embodiments, this can be done using the various sensors and by analyzing various input signals and contextual data.

For instance, the processors may utilize sensor data from the device's accelerometer and gyroscope to detect a stable position indicative of a tripod setup, suggesting the intent to capture a group photo. Additionally, the processors can analyze user interactions with the device, such as selecting a "group photo" mode within the camera application or setting a timer for delayed capture, which implies the photographer's inclusion in the image.

In another use case, the device may employ facial recognition algorithms to identify multiple faces in the frame, prompting the processors to suggest a multi-stage capture process to ensure all subjects, including the photographer, are included. Furthermore, the processors can leverage location data and historical usage patterns, such as frequent group photo captures at specific locations, to predict the requirement for a multi-stage photograph. These methods, individually or in combination, enable the electronic device to intelligently determine when capturing a group photograph in multiple stages is appropriate, thereby enhancing the user experience by automating the process and reducing the need for manual adjustments.

In step 202 of FIG. 2, upon determining that a sequential group photograph will be taken, the electronic device initiates a series of operations to facilitate the capture process. In one or more embodiments, the system launches the front-facing image capture device to gather information about the subject, capturing image sensor data that is important for framing and composition. Simultaneously, the rear-facing imager can be activated to collect data about the photographer, ensuring that both the subject and the photographer are appropriately positioned within the frame. This dual-camera setup allows for comprehensive data collection, enhancing the accuracy and quality of the final image composition.

Additionally, the front-facing display can be activated in one or more embodiments to present the image sensor data in a preview mode of operation. This real-time display provides immediate visual feedback to the user, allowing for adjustments in positioning and alignment before the photograph is captured. The preview mode is particularly beneficial in ensuring that the subject and photographer are correctly oriented relative to each other and any background elements, thereby optimizing the overall composition of the group photograph. This integrated approach leverages the capabilities of the electronic device's multi-camera and multi-display system to streamline the process of capturing sequential group photographs.

At step 203, the method 200 comprises identifying, by one or more processors, an object situated within a field of view of a first image capture device to be a focal point of one or more images. In one or more embodiments, step 203 comprises using one or more processors of an electronic device that are configured to identify an object depicted within the image sensor data for designation as a focal point of one or more images to be captured by the image capture device.

In some embodiments, this identification process can be enhanced through the use of artificial intelligence (AI), which employs advanced image recognition algorithms to analyze the image sensor data. The AI can be trained on vast datasets to recognize and classify various objects based on predefined criteria such as shape, color, and size. This allows the system to efficiently identify potential focal points, even in dynamic environments.

Examples of objects that can be identified include buildings, landscape items, landmarks, and celestial objects such as the sun, moon, and stars. By leveraging AI, the system can adapt to various contexts and user preferences, providing a personalized photography experience that highlights significant elements within the scene. This approach not only improves the accuracy and speed of object identification but also enhances the overall functionality of the image capture device, facilitating the creation of visually striking photographs with minimal user intervention.

At step 204 of FIG. 2, the method 200 generates a skeletal model to depict a subject in a predefined position relative to the depictions of the object designated as the focal point of the group image in the image sensor data, thereby obtaining augmented image sensor data. In one or more embodiments, this skeletal model is generated by the one or more processors, which may utilize data regarding the location of the subject relative to the focal point object found in the image sensor data captured at step 202.

Illustrating by example, in one or more embodiments the size of the skeletal model is dynamically adjusted based on this location data, ensuring that the model is appropriately scaled to match the spatial context of the focal point within the image to be captured. By accurately determining the distance and orientation of the first subject, the system can generate a skeletal model that aligns precisely with the intended composition, facilitating seamless integration of the other subjects into the final synthesized image. This method enhances the accuracy and aesthetic quality of the final composition by providing a visual guide for the subjects to align themselves correctly within the frame.

Step 204 can be performed in a variety of ways. In one or more embodiments, step 204 comprises generating a computer-generated model of a person executing a predefined activity. In another embodiment, the model may be simply a mapping of predefined reference locations corresponding to the subject reference locations are situated at predefined features of a subject to be depicted in one or more images, optionally performing the activity defined by the model.

In still another embodiment, the model is a geometric illustration of ideal alignments of the subject to be photographed. These examples of models are illustrative only, as numerous other examples will be obvious to those of ordinary skill in the art having the benefit of this disclosure.

In one or more embodiments, step 204 further comprises identifying, with the one or more processors, a plurality of standard reference locations situated at predefined features of a subject to be depicted in the one or more electronic images. In one or more embodiments, the plurality of standard reference locations corresponds to the plurality of subject reference locations situated at predefined features of what will become the depiction of the subject in one or more electronically captured images on a one-to-one basis.

Thus, if the identification of the subject reference locations occurring at step 204 can comprise identifying one or more predefined reference locations along the body of the subject, such as their eyes, ears, nose, neck, shoulders, elbows, hands, hips, knees, and feet. In one or more embodiments step 204 comprises identifying those same locations as the plurality of standard reference locations situated at predefined features of the model to be depicted in the one or more electronic images.

Accordingly, identification of the standard reference locations may comprise identifying eyes, ears, nose, neck, shoulders, elbows, hands, hips, knees, and feet of the depiction of the skeletal model, computer-generated standard, or other standard in the electronic images such that the standard reference locations correspond to the subject reference locations on a one-to-one basis in one or more embodiments.

Since the depictions of the already captured subject and the depictions of the to be captured subject may, absent embodiments of the disclosure, can be different in scale, location, rotational alignment, placement, size so forth, in one or more embodiments step 204 comprises performing, with the one or more processors of the electronic device, a Procrustes superimposition operation on one or both of the depiction of the subject in the captured images and/or the skeletal model generated to ensure that the size of the skeletal model and the size of the already depicted subject are similar in metrics. As such, in one or more embodiments the skeletal model generated at step 204 comprises a plurality of subject reference locations situated at predefined features of the second subject while depicted performing an activity with the first subject.

In one or more embodiments, this Procrustes superimposition operation occurring at step 204 comprises one or more of electronically translating, rotating, and scaling one or both of the depiction of the subject depicted in one or more electronically captured images and/or the skeletal model to be depicted in the one or more subsequent electronic images. Step 206 can then comprise augmenting, by one or more processors, the image sensor data to depict the skeletal model of a subject in a predefined position relative to depictions of the focal point to obtain augmented image sensor data. In one or more embodiments, step 206 can comprise a superimposition of either the skeletal model to be depicted in the one or more electronic images or a representation of the skeletal model to be depicted in the one or more electronic images.

In one or more embodiments, the photographer can define where the skeletal model should be positioned on the already captured image. Accordingly, in one or more embodiments step 206 comprises receiving, by a user interface, user input defining the predefined position.

Optional step 205 can comprise using a rear-facing imager to gather information about a photographer. Indeed, in one or more embodiments the rear-facing imager can capture an image of the photographer and then place that image atop the augmented image sensor data so that the subject, when aligning themselves with the skeletal model, can see the photographer being depicted in the group photograph that will result. Thus, in one or more embodiments step 205 comprises also receiving, by the one or more processors from another image sensor of another image capture device, other image sensor data depicting a user performing an image capture operation and further augmenting, by the one or more processors before the causing, the augmented image sensor data to include the other image sensor data depicting the user in another predefined position relative to the object.

In one or more embodiments, step 206 then comprises presenting, by the one or more processors on a front facing display, the augmented image sensor data while the image capture device is in a viewfinder mode of operation. Step 207 then comprises capturing an image depicting a first subject using an image capture device.

In one or more embodiments, step 207 comprises capturing, with the image capture device, another image depicting the subject after the second subject at least partially overlaps the skeletal model being presented on the front facing display while in the viewfinder mode of operation. In one or more embodiments, step 207 comprises capturing the other image automatically once the second subject overlaps the skeletal model being presented on the front facing display while in the viewfinder mode of operation by a predetermined threshold amount.

This step 207 can be executed in various scenarios to accommodate different user needs and environmental conditions.

For instance, in a scenario where the first subject is a person, the image capture device may utilize facial recognition technology to automatically focus and adjust exposure settings, ensuring optimal image quality. Alternatively, in a setting where the selected focal point is an inanimate object, such as a landmark or artwork, the device may employ scene recognition algorithms to enhance specific features of the subject, such as color and texture, to produce a visually appealing image.

In another scenario, the image capture device may be configured to operate in a low-light environment, where the device can automatically adjust ISO settings and activate a night mode to capture clear and detailed images of the first subject. These scenarios illustrate the versatility of the image capture device in adapting to various conditions to effectively capture the first subject in step 207.

At decision 208, the method 200 determines whether another person is to be added to the sequentially captured group photo by analyzing various contextual and sensor data. This decision can be made in a variety of ways.

For instance, the device may a utilize facial recognition technology from imaged captured with a rear-facing image capture device to determine whether the photographer has been depicted in the images captured to this point. The facial recognition technology may identify multiple faces within the frame, suggesting the presence of additional subjects who may need to be included in the final composition.

In another use case, the device could detect a stable position indicative of a tripod setup through accelerometer and gyroscope data, implying that the photographer intends to be part of the group photo. Additionally, user interactions such as selecting a "group photo" mode or setting a timer for delayed capture can trigger the decision to include the photographer in the image.

The device may also leverage historical usage patterns, such as frequent group photo captures at specific locations, to predict the need for a multi-stage photograph. These methods, individually or in combination, enable the electronic device to intelligently determine when capturing a group photograph in multiple stages is appropriate, thereby enhancing the user experience by automating the process and reducing the need for manual adjustments.

If no additional people are to be added, the photograph is rendered at step 209. However, where additional people are to be added to an already captured image, the method 200 moves to step 210.

In optional step 210 of FIG. 2, the method 200 may employ a depth imager to ascertain the distance between the image capture device and the subject of a captured image. The depth imager, which can be a stereo camera, structured light sensor, or time-of-flight sensor, may function by emitting light or infrared signals that reflect off the subject and return to the sensor.

By measuring the time required for the signals to return or by analyzing the disparity between images captured from slightly different angles, the depth imager calculates the distance to the subject with high precision. This distance information is useful in accurately generating a skeletal model of a second subject, ensuring that the model is appropriately scaled and positioned relative to the first subject – and the focal point - in the augmented image.

The use of a depth imager enhances the accuracy of the skeletal model's placement, thereby improving the overall quality and alignment of the final composite image. In one or more embodiments, step 210 determines, by one or more processors using one or more sensors while the image is being captured at step 207, a location of the first subject relative to the image capture device.

At step 212, one or more processors of the electronic device can prompt a user to take a next sequential photograph of the group image. One example of such a prompt is illustrated and described with reference to FIG. 3D below. Others will be obvious to those of ordinary skill in the art having the benefit of this disclosure.

At step 213 of FIG. 2, the method 200 generates a skeletal model to depict a second subject in a predefined position relative to the depictions of the first subject and the focal point, thereby obtaining an augmented image. This skeletal model is generated by the one or more processors, which may utilize data regarding the location of the first subject relative to the image capture device at the time the first image is captured.

In one or more embodiments, the photographer can define where the skeletal model should be positioned on the already captured image. Accordingly, in one or more embodiments step 214 comprises receiving, by a user interface, user input defining the predefined position.

In one or more embodiments, step 215 then comprises presenting, by the one or more processors on a rear facing display, the augmented image while the image capture device is in a viewfinder mode of operation. In one or more embodiments, step 216 comprises capturing, with the image capture device, another image depicting the second subject after the second subject at least partially overlaps the skeletal model being presented on the rear facing display while in the viewfinder mode of operation. In one or more embodiments, step 216 comprises capturing the other image automatically once the second subject overlaps the skeletal model being presented on the rear facing display while in the viewfinder mode of operation by a predetermined threshold amount.

In one or more embodiments, step 217 then comprises synthesizing, by the one or more processors, the image and another image to obtain a composite image depicting the first subject and the second subject in the predefined position relative to the depictions of the first subject. The process beginning at step 210 can then repeat if others are to be added to the group photograph. In one or more embodiments, step 212 of these subsequent loops comprises presenting, by the one or more processors on a front facing display, a prompt requesting that the another image be captured while the second subject at least partially overlaps the skeletal model when the augmented image is presented on the rear facing display in the viewfinder mode of operation.

Otherwise, once all the subjects have been photographed using the process (after the first subject) found in steps 210-217, step 209 can comprise presenting, by the one or more processors on a front facing display, the composite image.

Turning ow to FIG. 3A, illustrated therein are one or more method steps initiating a method in accordance with one or more embodiments of the disclosure. Beginning at step 301, Amit 303 and Roshni 304, having just savored a delightful meal at the world-famous Buster’s Chicken Stand, found themselves enchanted by the culinary landmark's rich history and the irresistible aroma of the signature honey-glazed drumsticks. Known for chicken served in eight delectable ways, Buster’s reputation is built on dishes like the crispy Southern-fried chicken, tangy lemon-pepper wings, and spicy Cajun grilled chicken, each offering a distinct taste experience that has captivated patrons for generations.

As the enticing scents of Buster’s creations lingered in the air, Amit 303 and Roshni 304 decided to extend their evening with a sunset stroll up the tallest peak 307 in Karnataka, India. The allure of the setting sun 305, combined with the lingering flavors of their meal, promised a delightful conclusion to their day, as they ascended the peak 307 to witness the breathtaking view, a moment that would be etched in their memories for a long time.

Enthralled by the moment, at step 301 Amit 303 proposes they capture the memory with a group photo beside the setting sun 305. However, Roshni 304 hesitates, pointing out the absence of anyone to assist them with the photo. Indeed, she exclaims, “But there’s nobody here to help us!” Roshni 304, having only experienced prior art electronic devices, simply presumes that they will need to find a bystander to take their collective photo or suffer with a poorly framed “selfie” due to Amit’s tendency to take photographs very quickly so that he can return to the office for his nightly litany of videoconference calls with co-workers around the world. Fortunately, Amit 303 was prepared with an electronic device 300, ingeniously configured in accordance with embodiments of the disclosure, enabling them to take an ideal group photo without needing a third party, thus preserving their visit to the peak 305 in a memorable picture.

At step 201, the one or more processors of the electronic device 300 can determine that a group photograph will be taken in multiple stages. This step 201 can be performed by employing a variety of techniques that enhance user experience and ensure optimal image composition.

One technique suitable for step 201 involves utilizing sensor data from the device's accelerometer and gyroscope to detect a stable position indicative of a tripod setup, which suggests the intent to capture a group photo. This technique is advantageous as it allows the device to automatically recognize the need for a multi-stage capture without user intervention.

Another technique suitable for step 201 includes analyzing user interactions with the device, such as selecting a "group photo" mode within the camera application or setting a timer for delayed capture, which implies the photographer's inclusion in the image. This approach provides flexibility and control to the user, allowing them to customize their photo-taking experience.

Additionally, at step 201 the electronic device 300 may employ facial recognition algorithms, using both the front-facing imager and rear-facing imager, to identify multiple faces in the respective frames. The one or more processors may then present a prompt to suggest a multi-stage capture process to ensure all subjects, including the photographer, are included. This technique is beneficial as it leverages advanced image processing capabilities to automatically adjust the capture process based on the detected number of subjects.

Furthermore, in other embodiments the processors can leverage location data and historical usage patterns at step 201, such as frequent group photo captures at specific locations, to predict the requirement for a multi-stage photograph. These methods, individually or in combination, enable the electronic device to intelligently determine when capturing a group photograph in multiple stages is appropriate, thereby enhancing the user experience by automating the process and reducing the need for manual adjustments.

At step 302, Amit 303 is using the electronic device 300 configured in accordance with one or more embodiments of the disclosure to capture at least one image 306 of a subject, which is Roshni 304. More specifically, the Amit 303 uses the front-facing imager of the electronic device 100 to capture the at least one image 306 of Roshni 304. The at least one image 306 could be a single static image, a series of burst images, a video stream, or another set of successively captured images.

In this illustrative embodiment, the electronic device 300 is a deformable electronic device in that the first device housing can be pivoted relative to the second device housing about a hinge between a closed position, shown at step 301, and an axially displaced open position shown at step 302. At step 302, Amit 303 has pivoted the first device housing relative to the second device housing to the axially displaced open position.

When this occurs, in one or more embodiments one or more sensors and/or flex sensors of the electronic device 300 detect the geometric form factor of the electronic device 300 exposing the rear-facing display and rear-facing imager. It should be noted that the front-facing imager and front facing display are exposed in both the axially displaced open position and closed position.

Additionally, at step 302 Amit 303 has launched an image capture application by delivering touch input to the rear-facing display. In one or more embodiments, this user input designates not only that one or more images will be captured, but that a group image taken in multiple stages will be captured. Additionally, this user input actuates the front-facing imager and allows the Amit 303 to see image content depicting the Roshni 304 by the peak 307 in the form of imager viewfinder content on the rear-facing display until he delivers additional user input to the rear-facing display initiating an image capture operation causing the at least one image 306 of the subject to be captured and stored non-transitorily in the memory of the electronic device 300.

In one or more embodiments, the imager viewfinder content comprises a stream of images sensed by the sensor of the front-facing imager and presented on one or more displays while the front-facing imager is actuated. In one or more embodiments, the imager viewfinder content is not stored in the memory other than in a transitory manner allowing presentation on those display(s).

Image capture operations performed at step 302 can include operations such as actuating an imager, launching an imager application, directing the lens of an imager toward a subject that they wish to photograph, and delivering user input causing an imager to one or more of actuate, capture light, focus on an object or scene, emit light from a flash, and/or capture one or more images. Other examples of image capture operations include the actuation of facial recognition algorithms that employ an imager to analyze light received in its field of view to identify various characteristics of a subject or scene. Still other examples of image capture operations will be obvious to those of ordinary skill in the art having the benefit of this disclosure.

In step 202 of FIG. 3A, upon receiving user input that initiates an image capture operation, the electronic device 300 is configured to activate the front-facing imager. This activation allows the device to capture image sensor data, which is then displayed in real-time on the front-facing display, providing the user with immediate visual feedback. The system is designed to enhance user interaction by offering a preview of the image composition, thereby facilitating adjustments before the final capture.

Additionally, the device can optionally activate a rear-facing imager, which serves to gather supplementary data about the photographer. This data collection can include facial recognition and other biometric information, which can be used to personalize the photography experience or to assist in aligning the photographer within the frame for group compositions. The integration of both front and rear imagers ensures a comprehensive data collection process, enhancing the overall functionality and user experience of the electronic device.

Turning now to FIG. 3B, at step 203 of FIG. 3B, the method involves the identification of an object situated within the field of view of a first image capture device to serve as a focal point for one or more images. This identification is performed by one or more processors, which utilize advanced image recognition algorithms to analyze the image sensor data captured by the device.

In this illustrative example, the processors are configured to recognize and prioritize objects of interest, such as natural landmarks or celestial bodies, based on predefined criteria like shape, color, and size. The processors can optionally employ machine learning models trained on extensive datasets to enhance their ability to detect and classify potential focal points accurately.

Specifically, in this scenario, the processors identify the beautiful setting sun 305 above the tallest peak in Karnataka as the focal point. This selection is facilitated by the system's capability to discern prominent features within the scene, ensuring that the most visually striking element is highlighted in the captured images. By designating the setting sun as the focal point, the method enhances the aesthetic appeal of the photograph, allowing users to capture a memorable and visually striking composition.

At step 311 of FIG. 3B, the one or more processors of the electronic device are configured to present a prompt 314 on the display, indicating that the setting sun 305 has been detected as the focal point within the image sensor data. This prompt 314 serves as a visual notification to the photographer, providing an intuitive interface for confirming the selection of the detected focal point.

In one or more embodiments, the prompt 314 is designed to enhance user interaction by offering the photographer the option to either accept the setting sun 305 as the focal point or to define an alternative focal point within the scene. This functionality is achieved through a user interface that allows the photographer to interact with the prompt 314, such as by tapping or selecting on the display, thereby enabling the customization of the focal point according to the photographer's preference. This feature ensures that the photographer has control over the composition of the image, allowing for personalized and contextually relevant photographic outcomes.

In step 204 of FIG. 3B, the one or more processors of the electronic device are configured to augment the image sensor data received from the front-facing image capture device by generating a skeletal model of one or more subjects. These skeletal model(s) Are strategically positioned to interact with depictions of the identified object, which serves as the focal point within the image sensor data.

In one or more embodiments, the augmentation process involves utilizing advanced image recognition algorithms to analyze the spatial relationship between the subject and the object, ensuring that the skeletal model is accurately aligned and scaled to fit the context of the scene. By superimposing this skeletal model onto the image sensor data, the processors create augmented image sensor data that provides a visual guide for the subject's interaction with the object, thereby enhancing the composition and aesthetic appeal of the final image. This method allows for real-time feedback and adjustment, facilitating the seamless integration of the subject into the scene and improving the overall user experience in capturing complex photographic compositions.

In step 312 of FIG. 3B, the electronic device is configured to generate and display a first skeletal model 316 of Roshni and a second skeletal model 317 of Amit, strategically positioned to create the illusion of interacting with the setting sun in the augmented image sensor data 315. In this illustrative example, the skeletal models are presented in predefined positions that align with the spatial context of the scene, allowing the hands of Amit and Roshni to appear as if they are holding, leaning on, or pushing the sun.

In one or more embodiments, this visual effect is achieved by utilizing advanced image processing algorithms that analyze the spatial relationship between the subjects and the focal point, ensuring that the skeletal models are accurately scaled and oriented within the augmented image. By superimposing these models onto the image sensor data, the system provides real-time guidance for the subjects to align themselves with the depicted positions, enhancing the aesthetic appeal and creativity of the final photograph.

In step 312 of FIG. 3B, the method can further include presenting a prompt 318 on the display, which allows the photographer to reposition the skeletal models 316 and 317 if the initial positioning relative to the focal point object is unsatisfactory. This prompt 318 provides an interactive user interface element that enables the photographer to manually adjust the placement of the skeletal models, ensuring that the final composition aligns with the photographer's creative vision.

By selecting the prompt 318, the photographer can access a set of controls or gestures that facilitate the repositioning of the skeletal models, allowing for adjustments in orientation, scale, and position within the augmented image sensor data. This feature enhances the flexibility and customization of the image composition process, empowering the photographer to achieve a more precise and aesthetically pleasing arrangement of subjects in relation to the focal point object.

In one or more embodiments, step 205 optionally involves utilizing the rear-facing camera to gather data about the photographer. This process includes capturing images of the photographer, which can be used to create a cutout image. The cutout image of the photographer is then superimposed on the augmented image sensor data. This augmented data, now including the photographer's cutout, is presented on the front-facing display. Thus, in one or more embodiments step 205 comprises augmenting at least one augmented image with other image sensor data received from a second image capture device that depicts a user of the electronic device interacting with the object.

By doing so, the subjects to be captured in subsequent images can see the photographer's position within the composition, allowing for better alignment and interaction with the focal point and other subjects. This feature enhances the overall composition by providing a visual reference for the subjects, ensuring that the photographer is seamlessly integrated into the final group photograph.

Turning now to FIG. 3C, at step 321 the system enhances the augmented image sensor data 324 by replacing the skeletal model of the photographer with a cutout image 325 of the photographer. This transformation is achieved by utilizing image processing techniques that capture the photographer's likeness and integrate the likeness into the augmented image.

In one or more embodiments, the cutout image 325 is generated using data from the rear-facing image capture device, which captures the photographer's image while they are positioned within the field of view. By incorporating the cutout image into the augmented image sensor data 324, the system provides a realistic depiction of the photographer, allowing subjects within the field of view of the front-facing image capture device to see a more lifelike representation. This approach not only enhances the visual accuracy of the composition but also facilitates better alignment and interaction between the subjects and the photographer, thereby improving the overall quality and coherence of the final group photograph.

Illustrating by example, at step 323 of FIG. 3C Amit 303 is ready to take Roshni’s picture, with Roshni 304 situated within a field of view 306 of the front-facing image capture device of the electronic device 300. Impressed, Roshni 304 exclaims, “Oh wow! I can see you!”

At step 322 of FIG. 3C, Roshni 304 utilizes the skeletal model presented on the display as a preview image 326 to align herself in the proper position relative to the image cutout of Amit that has been applied to the preview image 326 and the setting sun. As shown, the skeletal model serves as a visual guide, providing reference points that correspond to predefined features of Roshni's body, such as her hands, shoulders, and head. This allows Amit 303 to capture her image 305 while she’s in the field of view 306 of the image capture device at step 323.

By adjusting her posture to match the skeletal model, Roshni 304 ensures that her alignment with the setting sun and Amit's image cutout is precise, creating the intended visual effect of interacting with the background object. This alignment process is facilitated by the real-time feedback provided by the display, which allows Roshni 304 to make necessary adjustments to her position until the skeletal model and her actual posture are in congruence. Once Roshni 304 achieves the desired alignment, the system optionally automatically captures her image, ensuring that the final photograph accurately reflects the creative composition envisioned by the users at step 207.

In step 207 of FIG. 3C, the method involves capturing, with the image capture device, at least one other image depicting another subject after the subject at least partially overlaps the skeletal model being presented on the first display while in the preview mode of operation. This step 207 ensures that the subject is accurately aligned with the predefined skeletal model, which serves as a visual guide for optimal positioning relative to the focal point object.

In one or more embodiments, the system is configured to optionally automate this process occurring at step 207 by capturing the image once the subject overlaps the skeletal model by a predetermined threshold amount. This automation reduces the need for manual intervention, allowing for precise and efficient image capture, thereby enhancing the overall user experience by ensuring that the final composition is both aesthetically pleasing and accurately aligned with the intended design.

In decision 208 of FIG. 3C, the method involves determining whether another person is to be added to the group photograph by analyzing various contextual and sensor data. This decision-making process can utilize facial recognition technology to identify multiple faces within the frame, suggesting the presence of additional subjects who may need to be included in the final composition.

Additionally, the device may detect a stable position indicative of a tripod setup through accelerometer and gyroscope data, implying that the photographer intends to be part of the group photo. User interactions, such as selecting a "group photo" mode or setting a timer for delayed capture, can also trigger the decision to include the photographer in the image. Furthermore, the device may leverage historical usage patterns, such as frequent group photo captures at specific locations, to predict the need for a multi-stage photograph.

In this illustrative example, since Amit 303 still needs to be added, the method proceeds to FIG. 3D, where the system prompts the capture of the next sequential photograph, ensuring that all intended subjects are included in the final group composition. Turning now to FIG. 3D, the method steps illustrated therein begin with the photograph 330 of Roshni 304 taken with the setting sun. As shown, the photograph puts Roshni 304 in a predefined position resulting in her hand being depicted holding the setting sun.

In step 210 of FIG. 3D, the electronic device is configured to optionally determine the distance Roshni 304 is from the image capture device when the photograph 330 is taken. This determination can be achieved using a depth imager, which may include technologies such as stereo cameras, structured light sensors, or time-of-flight sensors. The depth imager operates by emitting light or infrared signals that reflect off Roshni 304 and return to the sensor, allowing the device to calculate the distance based on the time it takes for the signals to return or by analyzing the disparity between images captured from slightly different angles.

This distance information, where gathered, can be beneficial in accurately scaling and positioning another skeletal model relative to Roshni 304 at step 211, thereby ensuring that the model is appropriately aligned within the augmented image. By leveraging this technology, the system enhances the accuracy of the skeletal model's placement, thereby improving the overall quality and alignment of the final composite image.

In step 212 of FIG. 3D, the electronic device is configured to optionally prompt the user to capture another photograph as part of the sequential group photo process. One such prompt 333 is shown illustratively at step 331, although others will be obvious to those of ordinary skill in the art having the benefit of this disclosure. In one or more embodiments the prompt 333 requests that at least one other image be captured while the another subject at least partially overlaps the another skeletal model when the at least one augmented image is presented on the first display in the preview mode of operation.

In one or more embodiments, this prompt can be delivered through various methods, such as a visual cue on the display, an audible alert, or haptic feedback, ensuring that the user is aware of the need to capture the next image. The visual cue may include a flashing icon or a highlighted button on the display, providing a clear and immediate signal to the user. An audible alert, such as a beep or a spoken instruction, can be beneficial in situations where the user is not directly looking at the display, ensuring awareness of the next step without needing to divert attention.

Additionally, haptic feedback, such as a vibration, can be used to notify the user, which is particularly useful in noisy environments where visual and audible cues might be less effective. These prompting methods enhance the user experience by providing flexible and reliable notifications, ensuring that each stage of the group photograph is captured accurately and efficiently.

In step 213 of FIG. 3D, the electronic device's processors generate another skeletal model of another subject, strategically positioned to interact with other depictions of the setting sun. In one or more embodiments, this process involves utilizing advanced image processing algorithms to analyze the spatial context of the previously captured image, ensuring that the new skeletal model is accurately aligned with the existing composition.

In one or more embodiments, the one or more processors take into account the predefined position of the first subject and the focal point, which in this case is the setting sun, to determine the optimal placement and orientation of the new skeletal model. By doing so, the system provides a visual guide for the second subject to align themselves in a manner that creates the illusion of interacting with the setting sun, such as appearing to hold or lean on the sun.

In step 214 of FIG. 3D, the method involves augmenting, by the one or more processors, the at least one image 330 to depict another skeletal model 334 of another subject interacting with other depictions of the object to obtain at least one augmented image 335. Said differently, in one or more embodiments step 214 comprises augmenting, by one or more processors, the at least one image to depict another skeletal model of another subject in another predefined position relative to depictions of the object to obtain at least one augmented image, with step 215 presenting, by the one or more processors on the first display, the at least one augmented image while the image capture device is in the preview mode of operation.

In one or more embodiment, this process begins with the processors analyzing the spatial context of the previously captured image 330 to determine the optimal placement and orientation of the new skeletal model 334. The processors utilize advanced image processing algorithms to ensure that the skeletal model 334 is accurately aligned with the existing composition, taking into account the predefined position of the first subject and the focal point, which in this case is the setting sun.

By superimposing the skeletal model 334 onto the image 330, the system provides a visual guide for the second subject to align themselves in a manner that creates the illusion of interacting with the setting sun, such as appearing to hold or lean on the sun. This augmentation enhances the aesthetic appeal and creativity of the final photograph, allowing for seamless integration of the second subject into the scene.

The at least one augmented image 335 is shown being presented on the front facing display in a preview mode of operation at step 332. Thus, in one or more embodiments step 332 comprises presenting, by the one or more processors, the at least one augmented image on the first display while the first image capture device is operating in a viewfinder mode of operation.

Turning now to FIG. 3E, in one or more embodiments step 216 comprises capturing, by the first image capture device while the at least one augmented image is being presented on the first display, at least one other image of another subject sufficiently overlaps the another skeletal model. As shown at step 340, Amit 303 utilizes the at least one augmented image 341, which is being presented in a viewfinder mode of operation on the front facing display, to align himself with the second skeletal model. This augmented image serves as a real-time visual guide, displaying the skeletal model superimposed over the existing composition that includes Roshni's position and the setting sun.

By observing the augmented image on the display, Amit can adjust his posture and positioning to match the skeletal model's predefined alignment, ensuring that he interacts seamlessly with the depicted elements. The viewfinder mode provides continuous feedback, allowing Amit 303 to make precise adjustments until his alignment with the skeletal model is achieved. This process facilitates the creation of a cohesive and visually appealing composition, where Amit 303 appears to interact naturally with both Roshni and the setting sun, enhancing the overall aesthetic of the group photograph.

As shown at step 342, Roshni 304 is able to capture another photograph 343 of Amit 303 once Amit 303 sufficiently overlaps the second skeletal model. As noted above, in one or more embodiments, capture of this photograph 343 occurs automatically once Amit 303 sufficiently overlaps the second skeletal model.

Turning now to FIG. 3F, step 217 then comprises synthesizing, by the one or more processors, the at least one image and the at least one other image to obtain a synthesized image 350 depicting the subject and the another subject interacting with the object. In one or more embodiments, step 217 comprises presenting, by the one or more processors, the synthesized image 350 on a second display.

Illustrating by example, the synthesized image 350 may be presented on a rear facing display to the photographer. As shown, Amit and Roshni look so very happy atop Karnataka’s highest peak. Indeed, it looks as if they’re both holding the sun in the palms of their hands.

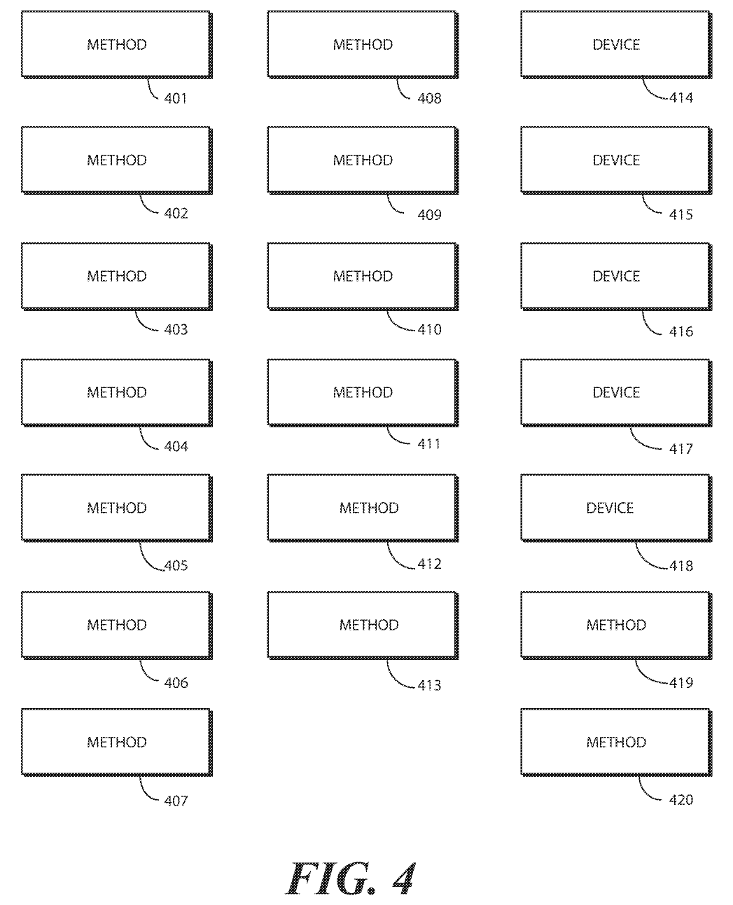

Turning now to FIG. 4, illustrated therein are various embodiments of the disclosure. The embodiments of FIG. 4 are shown as labeled boxes in FIG. 4 due to the fact that the individual components of these embodiments have been illustrated in detail in FIGS. 1-3F, which precede FIG. 4. Accordingly, since these items have previously been illustrated and described, their repeated illustration is no longer essential for a proper understanding of these embodiments. Thus, the embodiments are shown as labeled boxes.

At 401, a method in an electronic device comprises receiving, by one or more processors from an image sensor of an image capture device, image sensor data. At 401, the method comprises identifying, by the one or more processors using an image capture device, an object depicted within the image sensor data for designation as a focal point of one or more images to be captured by the image capture device.

At 401, the method comprises augmenting, by one or more processors, the image sensor data to depict a skeletal model of a subject in a predefined position relative to depictions of the object to obtain an augmented image sensor data. At 401, the method comprises causing, by the one or more processors, the augmented image sensor data to be presented on a user interface of the electronic device.

At 402, the presenting the augmented image sensor data of 401 occurs while the image capture device is operating in a preview mode of operation. At 403, the skeletal model of 402 comprises a plurality of subject reference locations situated at predefined features of the subject while depicted performing an activity with the object.

At 404, the user interface of 402 comprises a first display of the electronic device. At 405, the method of 404 comprises also receiving, by the one or more processors from another image sensor of another image capture device, other image sensor data depicting a user performing an image capture operation. At 405, the method comprises further augmenting, by the one or more processors before the causing, the augmented image sensor data to include the other image sensor data depicting the user in another predefined position relative to the object.

At 406, the first display of 405 is exposed both when a first device housing of the electronic device is pivoted about a hinge relative to a second device housing of the electronic device to a closed position and when the first device housing is pivoted about the hinge relative to the second device housing to an axially displaced open position. At 406, a field of view of the image capture device and another field of view of the another image capture device extend from the image capture device and the another image capture device, respectively, in opposite directions.

At 407, the method of 404 further comprises capturing, with the image capture device, at least one image depicting the object and the subject after the subject at least partially overlaps the skeletal model being presented on the first display while in the preview mode of operation. At 408, the method of 407 further comprises augmenting, by one or more processors, the at least one image to depict another skeletal model of another subject in another predefined position relative to depictions of the object to obtain at least one augmented image. At 408, the method comprises presenting, by the one or more processors on the first display, the at least one augmented image while the image capture device is in the preview mode of operation.

At 409, the method of 408 further comprises presenting, by the one or more processors on a second display, a prompt requesting that at least one other image be captured while the another subject at least partially overlaps the another skeletal model when the at least one augmented image is presented on the first display in the preview mode of operation. At 410, the method of 408 further comprises capturing, with the image capture device, at least one other image depicting the another subject after the another subject at least partially overlaps the another skeletal model being presented on the first display while in the preview mode of operation.

At 411, the capturing of 410 occurs automatically once the another subject overlaps the another skeletal model being presented on the first display while in the preview mode of operation by a predetermined threshold amount. At 412, the method of 410 further comprises synthesizing, by the one or more processors, the at least one image and the at least one other image to obtain a composite image depicting the object, the subject in the predefined position relative to the object, and the another subject in the another predefined position relative to object.

At 413, the object of 412 comprises one of a building, a landscape item, a landmark, a celestial object, and/or combinations thereof. At 413, the predefined position and the another predefined position result in hands of the subject and the another subject to be depicted holding, leaning on, and/or pushing the object.

At 414, an electronic device comprises a device housing supporting a first image capture device, a first display, and a second display and one or more processors. At 414, the one or more processors are configured to augment image sensor data received from the first image capture device to depict a model defined by reference locations situated at predefined features of a subject at a predefined position relative to a background object identified as a focal point by the one or more processors to obtain augmented image sensor data. At 414, the one or more processors cause the first display to present the augmented image sensor data while the first image capture device is operating in a viewfinder mode of operation.

At 415, the electronic device of 414 further comprises a second image capture device supported by the device housing. At 415, the one or more processors are further configured to further augment the image sensor data received from the first image capture device with other image capture device received from the second image capture device depicting a user performing an image capture operation at another predefined position relative to the background object.

At 416, the one or more processors of 414, upon the first image capture device capturing an image depicting a first subject in the predefined position, augment the image with another model defined by other reference locations situated at other predefined features of a second subject at another position relative to first facing display to present the other augmented image while the first image capture device is in the viewfinder mode of operation. At 417, the one or more processors of 416 cause the first image capture device to capture another image once the second subject overlaps the model by a predefined overlapping amount. At 418, the one or more processors of 417 further synthesize the image and the another image to obtain a composite image depicting the first subject and the second subject interacting with the background object.

At 419, a method in an electronic device comprises identifying, by one or more processors, an object situated within a field of view of a first image capture device to be a focal point of one or more images. At 419, the method comprises augmenting, by the one or more processors, image sensor data received from the first image capture device to depict a skeletal model of a subject interacting with depictions of the object to obtain augmented image sensor data.

At 419, the method comprises presenting, by the one or more processors, the augmented image sensor data on a first display. At 419, the method comprises capturing, by the first image capture device while the augmented image sensor data is being presented on the first display, at least one image of a subject and the object when the subject sufficiently overlaps the skeletal model.

At 419, the method comprises augmenting, by the one or more processors, the at least one image to depict another skeletal model of another subject interacting with other depictions of the object to obtain at least one augmented image. At 419, the method comprises presenting, by the one or more processors, the at least one augmented image on the first display while the first image capture device is operating in a viewfinder mode of operation.

At 419, the method comprises capturing, by the first image capture device while the at least one augmented image is being presented on the first display, at least one other image of another subject sufficiently overlaps the another skeletal model. At 419, the method comprises synthesizing, by the one or more processors, the at least one image and the at least one other image to obtain a synthesized image depicting the subject and the another subject interacting with the object.

At 419, the method comprises presenting, by the one or more processors, the synthesized image on a second display. At 420, the method of 419 further comprises augmenting at least one augmented image with other image sensor data received from a second image capture device that depicts a user of the electronic device interacting with the object.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in one embodiment the electronic device comprises a foldable smartphone with a front-facing image capture device integrated into the upper section of the device housing, allowing for seamless selfies and video calls. The front-facing display, which is a high-resolution OLED screen, provides a vibrant and clear viewfinder experience, enhancing the user's ability to interact with augmented reality features. The rear-facing display, located on the opposite side of the device housing, serves as a secondary screen for notifications and quick interactions, offering flexibility in device usage.

In another embodiment, the device housing is constructed from a lightweight, durable material such as aluminum or carbon fiber, ensuring both portability and robustness. The front-facing image capture device may include advanced features such as optical image stabilization and a wide-angle lens, enabling high-quality image capture in various lighting conditions.

Additionally, the one or more processors are configured to utilize machine learning algorithms to enhance image processing capabilities, providing real-time feedback and adjustments to the augmented image sensor data. In yet another embodiment, the electronic device could be a tablet with a detachable keyboard, where the front-facing display is larger, catering to users who prefer a bigger screen for augmented reality applications.

The device's modular design allows for easy upgrades and customization, such as swapping out the image capture devices for higher resolution or specialized lenses, thereby extending the device's functionality and lifespan. These embodiments illustrate the versatility and adaptability of the electronic device within the scope of the described technology, catering to a wide range of user preferences and use cases.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as critical, required, or essential features or elements of any or all the claims.

What is claimed is:

1. A method in an electronic device, the method comprising:
receiving, by one or more processors from an image sensor of an image capture device, image sensor data;
identifying, by the one or more processors using an image capture device, an object depicted within the image sensor data for designation as a focal point of one or more images to be captured by the image capture device;
augmenting, by one or more processors, the image sensor data to depict a skeletal model of a subject in a predefined position relative to depictions of the object to obtain augmented image sensor data; and
causing, by the one or more processors, the augmented image sensor data to be presented on a user interface of the electronic device.

2. The method of claim 1, wherein the presenting the augmented image sensor data occurs while the image capture device is operating in a preview mode of operation.

3. The method of claim 2, wherein the skeletal model comprises a plurality of subject reference locations situated at predefined features of the subject while depicted performing an activity with the object.

4. The method of claim 2, wherein the user interface comprises a front facing display of the electronic device.

5. The method of claim 4, further comprising:
also receiving, by the one or more processors from another image sensor of another image capture device, other image sensor data depicting a user performing an image capture operation;
further augmenting, by the one or more processors before the causing, the augmented image sensor data to include the other image sensor data depicting the user in another predefined position relative to the object.

6. The method of claim 5, wherein:
the front facing display is exposed both:
when a first device housing of the electronic device is pivoted about a hinge relative to a second device housing of the electronic device to a closed position; and
when the first device housing is pivoted about the hinge relative to the second device housing to an axially displaced open position; and
a field of view of the image capture device and another field of view of the another image capture device extend from the image capture device and the another image capture device, respectively, in opposite directions.

7. The method of claim 4, further comprising capturing, with the image capture device, at least one image depicting the object and the subject after the subject at least partially overlaps the skeletal model being presented on the front facing display while in the preview mode of operation.

8. The method of claim 7, further comprising:
augmenting, by one or more processors, the at least one image to depict another skeletal model of another subject in another predefined position relative to depictions of the object to obtain at least one augmented image; and
presenting, by the one or more processors on the front facing display, the at least one augmented image while the image capture device is in the preview mode of operation.

9. The method of claim 8, further comprising presenting, by the one or more processors on a rear facing display, a prompt requesting that at least one other image be captured while the another subject at least partially overlaps the another skeletal model when the at least one augmented image is presented on the front facing display in the preview mode of operation.

10. The method of claim 8, further comprising capturing, with the image capture device, at least one other image depicting the another subject after the another subject at least partially overlaps the another skeletal model being presented on the front facing display while in the preview mode of operation.

11. The method of claim 10, wherein the capturing occurs automatically once the another subject overlaps the another skeletal model being presented on the front facing display while in the preview mode of operation by a predetermined threshold amount.

12. The method of claim 10, further comprising synthesizing, by the one or more processors, the at least one image and the at least one other image to obtain a composite image depicting the object, the subject in the predefined position relative to the object, and the another subject in the another predefined position relative to object.

13. The method of claim 12, wherein:
the object comprises one of a building, a landscape item, a landmark, a celestial object, and/or combinations thereof; and
the predefined position and the another predefined position result in hands of the subject and the another subject to be depicted holding, leaning on, and/or pushing the object.

14. An electronic device, comprising:
a device housing supporting a front-facing image capture device, a front facing display, and a rear facing display; and
one or more processors;
wherein the one or more processors are configured to augment image sensor data received from the front-facing image capture device to depict a model defined by reference locations situated at predefined features of a subject at a predefined position relative to a background object identified as a focal point by the one or more processors to obtain augmented image sensor data and cause the front facing display to present the augmented image sensor data while the front-facing image capture device is operating in a viewfinder mode of operation.

15. The electronic device of claim 14, further comprising an rear-facing image capture device supported by the device housing, wherein the one or more processors are further configured to further augment the image sensor data received from the front-facing image capture device with other image capture device received from the rear-facing image capture device depicting a user performing an image capture operation at another predefined position relative to the background object.

16. The electronic device of claim 14, wherein the one or more processors, upon the front-facing image capture device capturing an image depicting a first subject in the predefined position, augment the image with another model defined by other reference locations situated at other predefined features of a second subject at another position relative to depictions of the background object to obtain other augmented image and cause the front facing display to present the other augmented image while the front-facing image capture device is in the viewfinder mode of operation.

17. The electronic device of claim 16, wherein the one or more processors cause the front-facing image capture device to capture another image once the second subject overlaps the model by a predefined overlapping amount.

18. The electronic device of claim 17, wherein the one or more processors further synthesize the image and the another image to obtain a composite image depicting the first subject and the second subject interacting with the background object.

19. A method in an electronic device, the method comprising:
identifying, by one or more processors, an object situated within a field of view of a first image capture device to be a focal point of one or more images;
augmenting, by the one or more processors, image sensor data received from the first image capture device to depict a skeletal model of a subject interacting with depictions of the object to obtain augmented image sensor data;
presenting, by the one or more processors, the augmented image sensor data on a first display;
capturing, by the first image capture device while the augmented image sensor data is being presented on the first display, at least one image of a subject and the object when the subject sufficiently overlaps the skeletal model;
augmenting, by the one or more processors, the at least one image to depict another skeletal model of another subject interacting with other depictions of the object to obtain at least one augmented image;
presenting, by the one or more processors, the at least one augmented image on the first display while the first image capture device is operating in a viewfinder mode of operation;
capturing, by the first image capture device while the at least one augmented image is being presented on the first display, at least one other image of another subject sufficiently overlaps the another skeletal model;
synthesizing, by the one or more processors, the at least one image and the at least one other image to obtain a synthesized image depicting the subject and the another subject interacting with the object; and
presenting, by the one or more processors, the synthesized image on a second display.

20. The method of claim 19, further comprising augmenting at least one augmented image with other image sensor data received from a second image capture device that depicts a user of the electronic device interacting with the object.
